(19) United States
(12) Patent Application Publication
(10) Pub. No.: US 2025/0022054 A1
(43) Pub. Date: Jan. 16, 2025

(54) SYSTEMS AND METHODS FOR AN ONLINE MARKETPLACE OF CLAIMS AND ADVANCE FUNDING

(71) Applicant: CLAIM ANGEL INC., Boca Raton, FL (US)

(72) Inventors: Theodore J. BERMAN, Delray Beach, FL (US); Russell F. BERMAN, Boca Raton, FL (US); Jeremy W. ALTERS, Golden Beach, FL (US); Logan A. ALTERS, Miami, FL (US); Benjamin H. CLARK, Newton, MA (US); Jason B. DAVIS, Woodstock, GA (US)

(21) Appl. No.: 18/901,785

(22) Filed: Sep. 30, 2024

Related U.S. Application Data
(63) Continuation-in-part of application No. 18/136,145, filed on Apr. 18, 2023.
(60) Provisional application No. 63/363,166, filed on Apr. 18, 2022.
(60) Provisional application No. 63/385,932, filed on Dec. 2, 2022.

(51) Int. Cl. G06Q 40/03; G06Q 20/08; G06Q 50/18

(52) U.S. Cl. CPC G06Q 40/03; G06Q 20/0855; G06Q 50/18

(57) ABSTRACT

Computer-implemented systems and methods for facilitating litigation funding advances are disclosed. The systems and methods may include performing steps for: receiving claim information on a contentious batch of one or more claims through an electronic portal; surfacing the claim information to one or more potential funders via the electronic portal, wherein the claim information comprises a payment schedule in return for a funding advance by the one or more potential funders; receiving one or more user inputs from a first funder among the one or more potential funders to transfer the funding advance for a first batch of one or more claims corresponding to the claim information; and initiating a first secure transaction between the one or more potential funders and a legal counsel of the first batch of one or more claims.

### RELATED APPLICATIONS

This application is a continuation-in-part of U.S. patent application Ser. No. 18/136,145, filed on Apr. 18, 2023, which claims priority to U.S. Provisional Application No. 63/363,166, filed on Apr. 18, 2022, and U.S. Provisional Application No. 63/385,932, filed on Dec. 2, 2022. The content of each of the above-referenced applications is hereby incorporated by reference in their entireties in the present application.

### TECHNICAL FIELD

The present disclosure generally relates to computerized methods and systems for an online marketplace platform. In particular, embodiments of the present disclosure relate to inventive and unconventional systems that bring together those looking for non-recourse funding advances on legal claims for damages; attorneys looking for non-recourse funding advances to cover the costs on contingent fee cases; and those willing to fund these claims or case costs requests per the terms laid out by the one seeking funding and/or the marketplace.

### BACKGROUND

When a person has a potential claim for damages against another, usually as the result of a tort-related injury such as a car accident, the person with the claim, the claimant, is considered a plaintiff in a suit and the person with the alleged liability is considered a defendant. While the most common type of claims result from personal injury cases such as medical malpractice, civil rights violations, employer misconduct, clerical abuse, wrongful death, and/or other damages sustained because of an incident/accident that generally sound in tort, there are many types of potential claims where one party may seek recovery from another. Such claims are often resolved between the plaintiff and the defendant pre-suit outside of court, where the defendant's insurance carrier provides the relief sought by the plaintiff by paying an amount up to the policy limits of the defendant's liability insurance. At other times, however, a defendant may deny any liability for the plaintiff's claim or be uninsured or underinsured and therefore unable to compensate the plaintiff for their damages. The claimant's recourse under such circumstance may then be to sue the defendant and either settle the case during litigation or obtain a judgment for relief. If the claimant has an uninsured/underinsured insurance policy of their own, it may also provide further monetary relief to plaintiff.

Claimants who have been damaged or injured and suffered losses, often have their lives and livelihoods disrupted to such an extent, that their earning capacity is diminished or they simply have higher expenses. The financial stresses can lead claimants to want to settle their claims fast and for less money than is actually required to fairly compensate them for their injuries and damages. Justice may be denied in such cases simply because of the claimant's need for money.

To ensure claimants do not under settle their claims, a claimant or attorney may seek advance funding from third parties. The third parties, i.e., funders, may advance funds for a claimant so they have money for medical care, bills, or food if they are unable to work due to their injuries or for attorneys so they have money to litigate the case. These funding advances are non-recourse, where there is no obligation of repayment if there is no recovery or fee on the funded claim. If the claim is not successfully resolved, funders will not be re-paid. In exchange for that risk, when a claim is successful, funders have a priority equitable lien on those proceeds and will be repaid for the funding advance with a very favorable escalation based on the age of the funding. Funders essentially buy a property interest in the claim from the claimant, and the value of the property interest may greatly increase.

This process has traditionally been a substantially manual process, where claimants, funders, and attorneys must seek out each other through word of mouth. This has led to much inconsistency in the market and for some funders to take advantage of the splintered market to get unfair rates of return. The lack of consistency has also given rise to needless complexities and substantial marketing costs for what can be an efficient and straight forward process and marketplace. Other attempts to create litigation funding websites have largely been simple implementations of word-of-mouth connections taking place online or predetermined funding products, where claimants are limited to a selection of funding advance products offered by funding entities.

Therefore, there is a need for a centralized online platform where all interested parties (e.g., claimants, legal counsels, and funders) can come together and connect in an efficient manner to provide and receive litigation funding.

### SUMMARY

One aspect of the present disclosure is directed to a computer-implemented system for facilitating litigation funding advances. The computer-implemented system may comprise at least one non-transitory computer-readable medium configured to store instructions; and at least one processor configured to execute the instructions, wherein the instructions may cause the at least one processor to perform: receiving claim information on a contentious batch of one or more claims through an electronic portal; surfacing the claim information to one or more potential funders via the electronic portal, wherein the claim information comprises a payment schedule in return for a funding advance by the one or more potential funders; receiving one or more user inputs from a first funder among the one or more potential funders to transfer the funding advance for a first batch of one or more claims corresponding to the claim information; and initiating a first secure transaction between the one or more potential funders and a legal counsel of the first batch of one or more claims.

Another aspect of the present disclosure is directed to a computer-implemented method for facilitating litigation funding advances. The method may comprise: receiving claim information on a contentious batch of one or more claims through an electronic portal; surfacing the claim information to one or more potential funders via the electronic portal, wherein the claim information comprises payment schedule in return for a funding advance by the one or more potential funders; receiving one or more user input from a first funder among the one or more potential funders to transfer the funding advance for a first batch of one or more claims corresponding to the claim information; and initiating a first secure transaction between the one or more potential funders and a legal counsel of the first batch of one or more claims.

Yet another aspect of the present disclosure is directed to a non-transitory computer-readable medium storing instructions which, when executed, cause at least one processor to perform operations for facilitating litigation funding advances. The operations may comprise: receiving claim information on a contentious batch of one or more claims through an electronic portal; surfacing the claim information to one or more potential funders via the electronic portal, wherein the claim information comprises a payment schedule in return for a funding advance by the one or more potential funders; receiving one or more user input from a first funder among the one or more potential funders to transfer the funding advance for a first batch of one or more claims corresponding to the claim information; and initiating a first secure transaction between the one or more potential funders and a legal counsel of the first batch of one or more claims.

### BRIEF DESCRIPTION OF THE DRAWINGS

FIG. 1 is a schematic block diagram illustrating an exemplary flow of information and process, consistent with the disclosed embodiments.

FIG. 2 depicts an exemplary home page of the online marketplace platform, consistent with the disclosed embodiments.

FIG. 3 depicts an exemplary search results page of the online marketplace platform, consistent with the disclosed embodiments.

FIG. 4 depicts an exemplary search results page of the online marketplace platform, showing a sample summary window for an exemplary claim, consistent with the disclosed embodiments.

FIG. 5 depicts an exemplary user dashboard of the online marketplace platform, consistent with the disclosed embodiments.

FIG. 6 depicts an exemplary claim details page of the online marketplace platform, consistent with the disclosed embodiments.

FIG. 7 depicts an exemplary payment page showing payment details, consistent with the disclosed embodiments.

FIG. 8 depicts an exemplary user profile registration page showing basic information of a user, consistent with the disclosed embodiments.

FIG. 9 depicts another exemplary user profile registration page showing experience and source information of the user, consistent with the disclosed embodiments.

FIG. 10 depicts an exemplary claim registration page of the online marketplace platform, consistent with the disclosed embodiments.

FIG. 11 depicts an exemplary mobile portfolio page on a mobile device, consistent with the disclosed embodiments.

FIG. 12 depicts an exemplary mobile gains and losses page on a mobile device, consistent with the disclosed embodiments.

FIG. 13 depicts an exemplary mobile funding page, consistent with the disclosed embodiments.

FIG. 14 depicts an exemplary administrator dashboard of the online marketplace platform, consistent with the disclosed embodiments.

FIG. 15 depicts an exemplary claim verification page showing history of prior reviews, consistent with the disclosed embodiments.

FIG. 16 depicts another exemplary user verification page showing history of prior reviews, consistent with the disclosed embodiments.

FIG. 17 depicts an exemplary payment management page, consistent with the disclosed embodiments.

FIG. 18 depicts an exemplary payment processing page, consistent with the disclosed embodiments.

FIG. 19 is a flow chart illustrating an exemplary process for user registration for claimants or funders and roles of different actors in the platform, consistent with disclosed embodiments.

FIG. 20 is a flow chart illustrating an exemplary process for listing a claim and being funded, consistent with disclosed embodiments.

FIG. 21 is a flow chart illustrating an exemplary process for relisting a claim by a claimant and switching to a new funder, consistent with disclosed embodiments.

FIG. 22 is a flow chart illustrating an exemplary process for relisting a claim by a claimant with hypothetical examples, consistent with disclosed embodiments.

FIG. 23 is a flow chart illustrating an exemplary process for relisting a claim by a funder and switching to a new funder with hypothetical examples, consistent with disclosed embodiments.

FIG. 24 is a flow chart illustrating an exemplary process for settling or closing a claim, consistent with disclosed embodiments.

### DETAILED DESCRIPTION

While several illustrative embodiments are described herein, modifications, adaptations and other implementations are possible. For example, substitutions, additions, or modifications may be made to the components, features, and information illustrated in the drawings, and the illustrative features described herein may be modified by substituting, reordering, removing, or adding steps to the disclosed features. Accordingly, the following detailed description is not limited to the disclosed embodiments and examples.

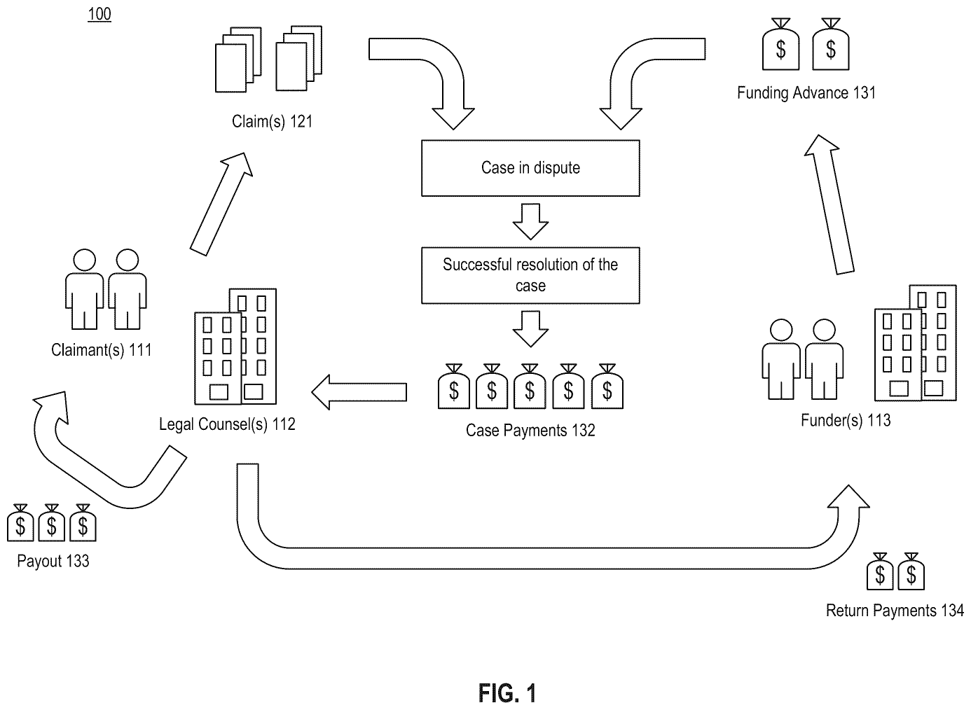

Referring to FIG. 1, a schematic block diagram 100 illustrating an exemplary flow of information and process enabled by the online platform is shown. As illustrated in FIG. 1, users of the online platform may be divided into three general groups: claimants 111, legal counsels 112, and funders 113, all of whom can be referred to collectively as users. References to each entity (e.g., claimants 111, legal counsels 112, and funders 113) may refer to user devices that each entity may use to access and navigate through the online platform as opposed to the entities themselves. User devices may include computing devices such as a computer, laptop, smartphone, tablet, or any other device configured for web-browsing.

As also used herein, legal counsels 112 may include attorneys, law firms, or any party providing legal counseling to claimants 111. Claimants 111 are those who have a claim 121 against another party, typically considered a plaintiff in a suit. As used herein, claim 121 may refer to a contentious claim where claimant 111 has a reasonable basis for seeking recovery from an opposing party. Such claim 121 may be adjudicated by a court or be settled between claimant 111 and the opposing party outside of court. In some embodiments, claim 121 may comprise, for example, personal injury cases such as medical malpractice, civil rights violations, employer misconduct, clerical abuse, wrongful death, and/or other damages sustained because of an incident/accident that generally sound in tort.

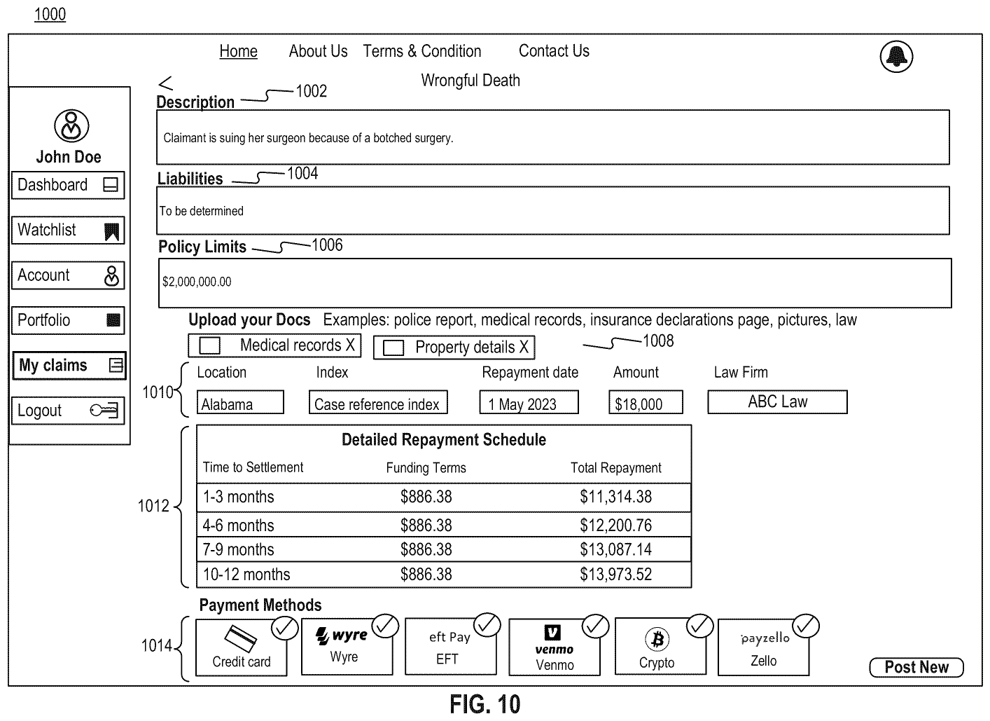

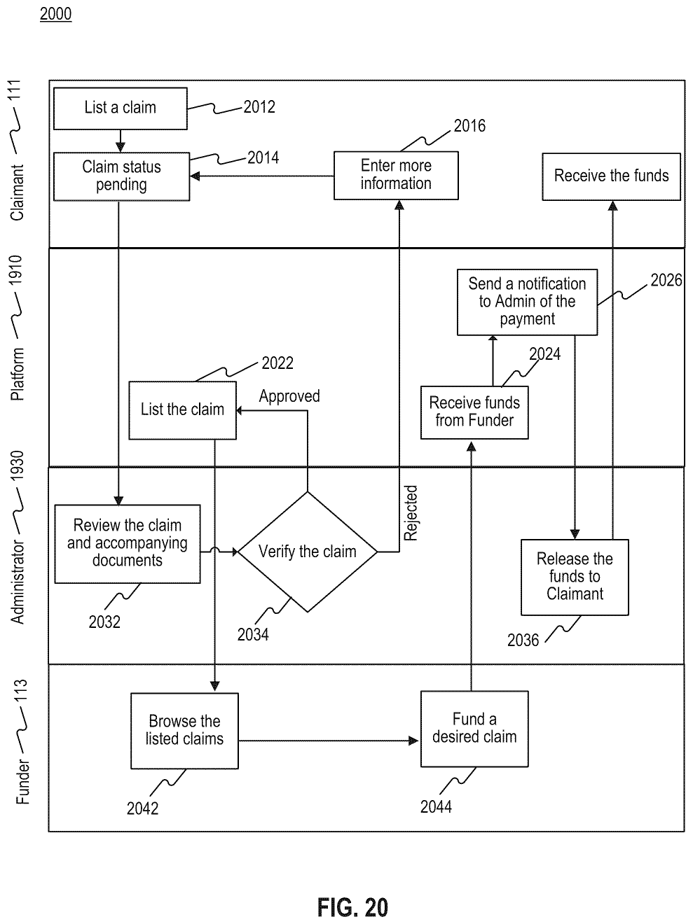

In some embodiments, a plurality of claims may be represented by a single batch of claims. A batch of claims may refer to a collection of two or more claims seeking, from a funder 113, a total amount of funds based on the funds sought for each of the claims of the batch of claims. For example, the total amount of funds may be equal to a sum of sought funds for the claims in a batch; a weighted sum of sought funds, including applying one or more multipliers (e.g., 0.5, 0.75, 0.9, or any other suitable number) to one or more sought funds and/or the sum of the sought funds (e.g., based on a determined rating, as described and exemplified with respect to online platform 1910); the sum of sought funds for a subset of the claims in a batch, the subset being determined by a method and constituting a different batch, or any other determination method for combining a set of values. In some embodiments, a batch of claims may be listed by a user (e.g., legal counsel 112). Additionally or alternatively, in some embodiments, a batch of claims may be created by a user based on existing listed or funded claims. Each process is exemplified and described further with respect to FIGS. 10 and 20.

In some embodiments, a batch of claims may comprise a plurality of claims sharing at least one common characteristic. For example, a batch of claims may comprise a plurality of claims having a same type (e.g., personal injury), represented by a same legal counsel 112, having a same or similar (e.g., within a predetermined range) rating, any combination of the foregoing, or any other claim information.

Claimants 111 using the disclosed platform would be in need of non-recourse funding advances to pursue the claims 121. Legal counsels 112 are those that represent a claimant 111 and pursue resolution of the claim 121 either pre-litigation or by filing a lawsuit. Similarly to claimants 111, legal counsels 112 using the disclosed platform, who must advance costs and bear the risks of contingent fee outcomes, would be looking for non-recourse funding advances to cover the cost of pursuing claims 121 and representing the claimants 111, and such costs can be significant. The funding advances would allow legal counsels 112 to handle more claimants 111 and costs and remove some of the risk of unsuccessful claims 111 where they would lose all the advanced costs. Funders 113 are individuals or business entities that can provide funding advance 131 as non-recourse funding advance in return for future payments (i.e., return payments 134) from a claimant's successful suit or an attorney's collection of fees when successfully resolving their client(s)′ claims 121. As used herein, case payments 132 may refer to a lump sum payment from the opposing party (e.g., defendant). In some embodiments where legal counsels 112 represented claimants 111 in a legal suit, case payments 132 may be paid to the legal counsels 112, who may then deduct their fees and other costs such as medical bills and transfer the rest to claimants 111 as payout 111. Return payments 134 may be deducted from case payments 132 as part of the other costs and be routed through the online platform as described in more detail below. In some embodiments, return payments 134 may be paid as a first position lien on case payments 132, before other costs are paid. In other embodiments where claimants 111 pursued their claims 121 pro se or outside of court without legal counsel 112, claimants 111 may take up the role of deducting the other costs, including return payments 134. In some embodiments, claimants 111, legal counsels 112, and funders 113 can be individuals, law firms, business entities, or other persons/entities. Additional detail may be required for organizational users, such as a certificate of incorporation, state Bar number, and/or tax identification number.

For example, a claimant 111 is rear ended and needs a surgery. The owner of the rear-ending car, i.e., the defendant, may have an insurance policy that can pay up to $250,000, and the defendant in this case would have clear liability because of the nature of the crash. The value of the claimant's claim 121 may be $250,000, but the insurance company may be offering only $10,000 to resolve the claim 121. The claimant 111 may be in need of a non-recourse funding advance on the claim 121 in order to have money for post-operative care and/or living expenses while missing work. The claimant may need a non-recourse funding advance of $10,000 on his claim 121 in order assure that he does not under settle the case for money now and ensure that he gets the full value of his claim 121.

The claimant 111 can post a proposal for his claim 121 and request $10,000 in funding advance 131 on the platform. Then a person or entity (i.e., funder 113) looking to fund a claim for return on their money can look for such proposal of a certain amount or range. At this point the claimant's claim 121 may be shown, along with any other claims that fit the funder's search criteria. The funder 113 would be able to see a snapshot of the claim 121 and register to see additional details of the claim 121, which have been verified by the platform.

Claimants 111 may base the amount of their request and the amount they are willing to repay to a funder 113 on a suggestion from the platform or they may set the amount themselves, or in some embodiments the platform may set a standard repayment amount or calculation.

Similarly, legal counsels 112 seeking funding to cover the costs of pursuing claims 121 may use the disclosed platform as well. Legal counsel 112 that advanced costs on, for example, personal injury cases has traditionally been unable to recoup the costs until the case has been resolved. This can leave the legal counsel 112 with significant funds tied up in pending cases. Using the disclosed platform would allow the legal counsel 112 to receive funding advance 131 from a funder 113 in order to properly continue handling the case. The legal counsel 112 can decide how much they want in order to represent a claimant 111, post a proposal on the platform with the ask, and be matched with a funder 113 looking to provide the funding advance 131 for a guaranteed return when the legal counsel 112 is paid on the funded cases. For example, a legal counsel 112 can seek $5,000 in costs to secure an expert for an upcoming trial. The disclosed platform would thus provide easier access to funds to pay for that expert and continue adequately representing a client.

Once the claimant 111 or the legal counsel 112, and the funder 113 decide to make a deal, the online platform disclosed below can provide documents to complete the transaction.

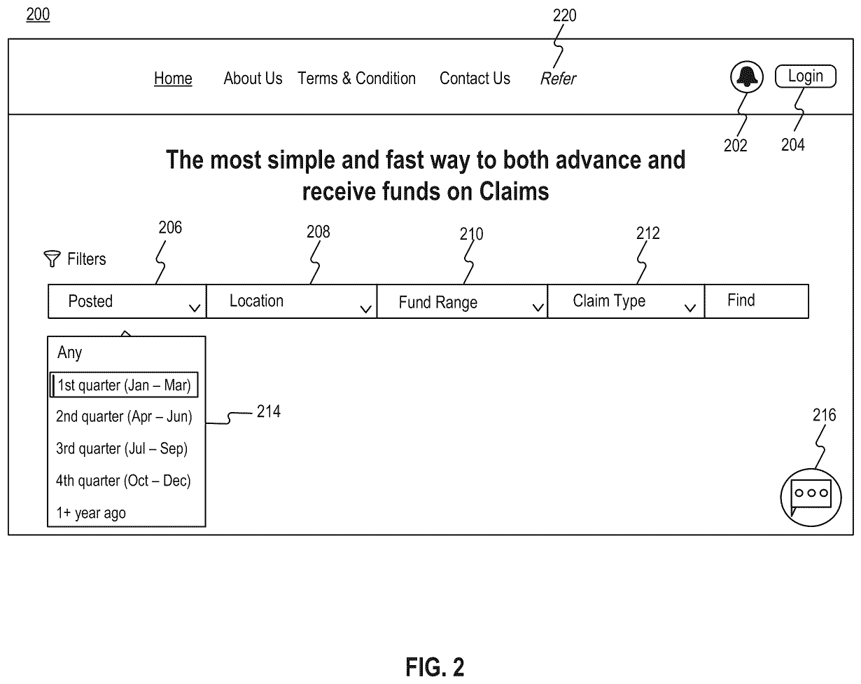

Referring to FIG. 2, an exemplary home page 200 of the online marketplace platform is shown. In some embodiments, the home page 200 may comprise ancillary buttons such as a notification button 202, a login button 204, and a chat button 216. The home page 200 may also comprise a main user interface (UI) pane configured to show UI for search through available claims 121. For example, the main UI pane may comprise filter buttons for posted date 206, location 208, fund range 210, and claim type 212. A user input received on any of the filter buttons may bring up a corresponding dropdown menu (e.g., posted date menu 214) with a list of options for filtering available claims 121.

In some embodiments, dropdown menus for the filters may further comprise, for example, a list of geographical regions such as states, counties, and/or districts, a list of monetary ranges such as $0 to $5000, a list of predetermined categories such as claim type (e.g., car accident, medical malpractice, slip and fall), or any other list of options (e.g., whether claims 121 are listed for the first time, relisted, or transferred from a third party litigation funding service) that can group the claims 121 into subsets. The values described herein and depicted in FIG. 2 are only intended to be exemplary and are freely adjustable to suit users' needs. Furthermore, other user interface elements for accepting a user's selection, such checkmarks or radio buttons, and other descriptions of options can be used as known in the art. For example, filters for the posted date 206 may comprise a number of days, such as “today,” “7 days ago,” “14 days ago,” etc.

Referring again to FIG. 2, a user interface for logging into the online platform or registering as a new user may be called via the login button 204. The registration process may require a prospective user's personal information such as legal name and contact information. The registration process may also require financial information such as bank or credit card information. In some embodiments, alternative currency financial accounts, such as cryptocurrency wallet, or peer-to-peer money exchange accounts may be requested. Still further, the platform may require certain types of financial information based on specific types of users. For example, the platform may require bank account information (or a means for receiving funds) for claimants 111 or legal counsels 112 (including a bank account or means for receiving funds associated with a law firm of legal counsels 112), so that they can receive case advance funding 131, and require credit card information (or a means for transferring funds) for funders 113 so that they can send case advance funding 131. In further embodiments, the platform may require other special categories of personal data such as biometric information for additional authentication.

In some embodiments, the platform may require proof of financial information from the user, such as a bank statement, and/or verify the information using micro transactions to the provided account and having the user confirm the amounts of the micro transactions. For an extra layer of security, the platform may also require individual review and approval of new accounts by administrators. In some embodiments, the platform may create and manage a financial account for each user, which can store each users' funds for quick access without having to wait for financial institutions to process fund transfer requests.

In further embodiments, each new user account may be subject to manual or automatic review, which can identify any problems with new accounts before they can begin using the platform. The review may identify, for example, false or fraudulent information or unintelligible profile pictures. In other embodiments, the review may include inquiries to third party agencies, including but not limited to credit bureaus, fraud prevention agencies or financial crime agencies. Any deficiency and actions taken to address them can be stored in a log and provided to administrators for policing.

Still further, the registration process may involve utilizing third party services for verification. For example, an Application Programming Interface (API) of a third-party service may be incorporated into the user interface for registering new users to verify a prospective user's identity using only a limited set of information (e.g., name and last four digits of social security number). Additionally or alternatively, the user interface may accept a statement or a verification from the legal counsel 112 of a prospective claimant 111 to verify identity of the prospective claimant in the signup process. The user interface may also implement API of another third-party service for connecting a user's account to the user's financial account.

In further embodiments, users may also be able to contact representatives of the online platform for help through an instant messaging function or through other means of communication. A user interface for instant messaging function may be called via the chat button 216. Additionally or alternatively, the chat button 216 may be configured to allow instant messaging between users of the online platform. Still further, the platform may comprise other communication capabilities such as its own email client for communicating with external users (e.g., email communications from prospective users) and/or instant messaging platform for exchanging quick communications (e.g., for technical support).

In some embodiments, the platform may include a referral system in which a current user may refer a prospective user. For example, legal counsel 112 may use the referral system with a client seeking funding. The referral system may include an interactable graphical user element (e.g., referral button 220) displayed by the platform configured to, in response to detecting a user interaction with the interactable graphical user element, generate an invitation (e.g., email including a link associated with a referring user account, e.g., legal counsel 112). Additionally or alternatively, the referral system may include integration with a third-party site (e.g., website associated with legal counsel 112) via an API. In some embodiments, sending a referral via the referral system may include inviting a prospective user to join a pending or draft claim submission. For example, legal counsel 112 may invite a claimant 111 to register with the online platform and be associated with a pending or draft claim.

In some embodiments, when a prospective user registers with the online platform as a user (e.g., claimant 111, legal counsel 112, funder 113) via the referral system, one or more claim information for a claim may be automatically generated by the online platform. For example, a claim registration page (as described and exemplified further with respect to FIG. 10) for the newly registered user may include a partially completed claim, including claim information completed or submitted by legal counsel 112.

In some embodiments, the online platform may record and store data including a number of registered users referred by a particular user. For example, the online platform may store (e.g., in a database) a value associated with each registered user indicating a number of times a user registered with the online platform using an invitation or referral by the registered user. The online platform may, based on the value, elevate or promote pending claims associated with the registered user.

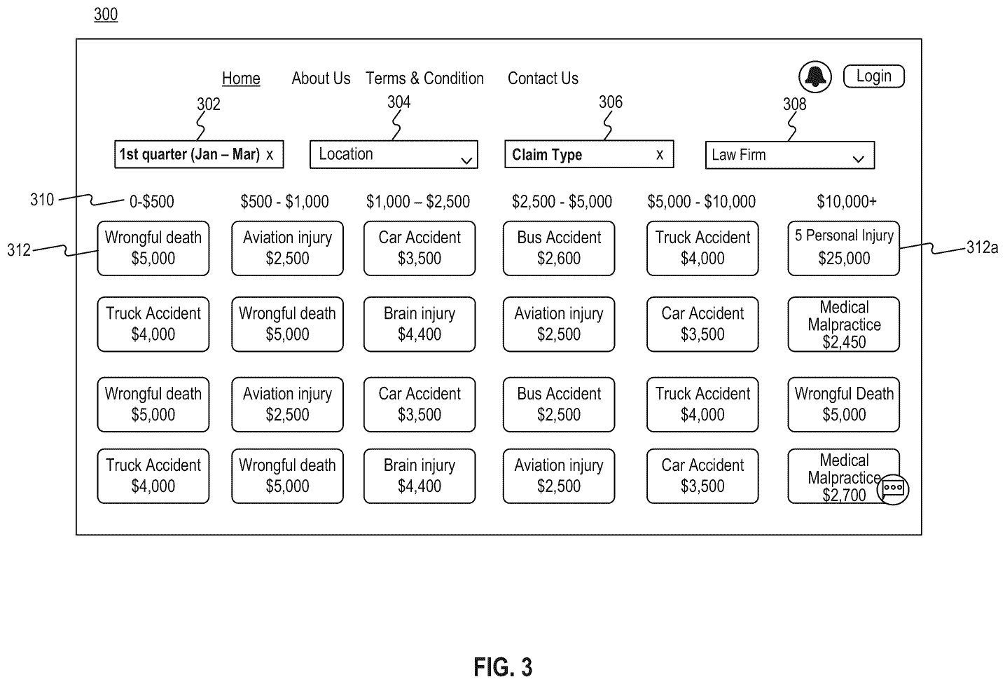

FIG. 3 depicts an exemplary search results page (SRP) 300 of the online platform, showing a series of claims 121, represented by claim buttons 312, that meet the user's search criteria. SRP 300 and home page 200 may be publicly accessible by users regardless of whether they are logged into the online platform or not, which may be advantageous for attracting more audience or potential registered users. Additionally or alternatively, SRP 300 may be configured to control display of different claims 121 based on the type of user (e.g., claimant 111, legal counsel 112, funder 113, or administrator of the online platform) or authorization level.

In some embodiments, SRP 300 may comprise a set of filter buttons corresponding to the filter buttons depicted in FIG. 2, such as for posted date 302, location 304, claim type 306, or legal counsel 308. Additionally or alternatively, SRP 300 may display a filter bar 310 showing a list of options arranged in a bar. Clicking on any of the options (e.g., “$2,500-$5,000”) may prompt SRP 300 to display claims 121 that meet the selected option and thus allow a user to quickly switch between different options. In some embodiments, one filter may include an option to filter by batches claims. By way of non-limiting example and with reference to FIG. 3, claim button 312a may be associated with a batch of claims (“5 Personal Injury”) seeking a total of $25,000.

For example, users could search for and quickly browse claims 121, where claimants or legal counsel are seeking $500 in funding advance 131 using the filter bar 310. In another example, a funder 113 could search for a prestigious law firm with a good rate of success using the legal counsel filter button 308 and advance costs for one or more of the law firm's claims 121. Claims 121 funded by a funder 113 may be added to the funder's portfolio as explained below.

In some embodiments, SRP 300 may display claim buttons 312 in one of various different patterns, including but not limited to: the date of listing, funding advance 131 amount, or the like. In further embodiments, SRP 300 may display claim buttons 312 in the order of its impact on the online platform, such as the amount of storage space the corresponding claim 121 takes in a database of the online platform, indicating that the corresponding claim 121 contains a lot of details; the amount of user inputs (e.g., clicks, view counts) that each claim button 312 received; the amount of network traffic each claim button 312 received, indicating the amount of user interest garnered by the corresponding claim 121, or the like. For example, the online platform may monitor each claim button 312 or the corresponding claim's 121 impact on the online platform and update SRP 300 to automatically move claim buttons 312 with the highest impact to a position on SRP 300 closest to the top left corner.

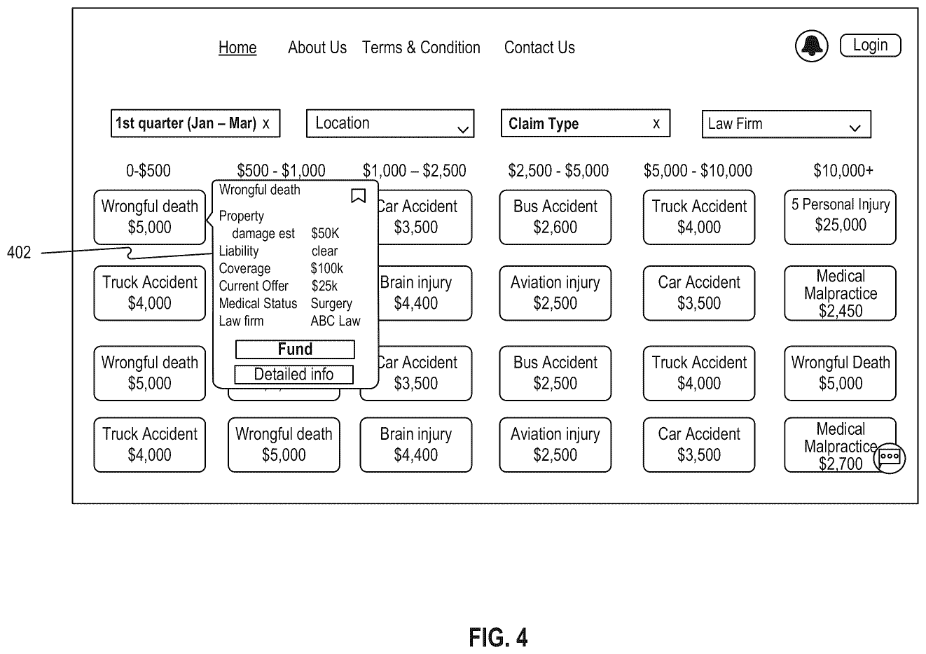

Referring to FIG. 4, a claim summary popup 402, a popup window comprising a high-level summary of a claim 121, is shown. A user input directed at each claim button 312 may prompt the online platform to display claim summary popup 402. For example, a user may click on a claim button 312 or hover over the button to display claim summary popup 402. In some embodiments, various information such as the type of claim (e.g., “wrongful death”), amount of funding advance 131 sought (e.g., $5,000), a title set by claimant 111 or legal counsel 112, or any other information available from the corresponding claim 121 may be displayed. In some embodiments, information displayed for one claim may be different from that displayed for another claim. In some embodiments, the name of the legal counsel 112 contracted to represent the claimant 111 may also be displayed.

In some embodiments, when a user input is directed at a claim button associated with a batch of claims (e.g., claim button 312a), the online platform may prompt the online platform to display a batch of claims summary. The batch of claims summary may include batch of claims information, such as: a listing of each claim of the batch, the amount of funding sought for each claim of the batch, any multiplier applied to the amount of funding sought for any claim or the total amount sought, the type of each claim, or any other information available from the corresponding batch of claims.

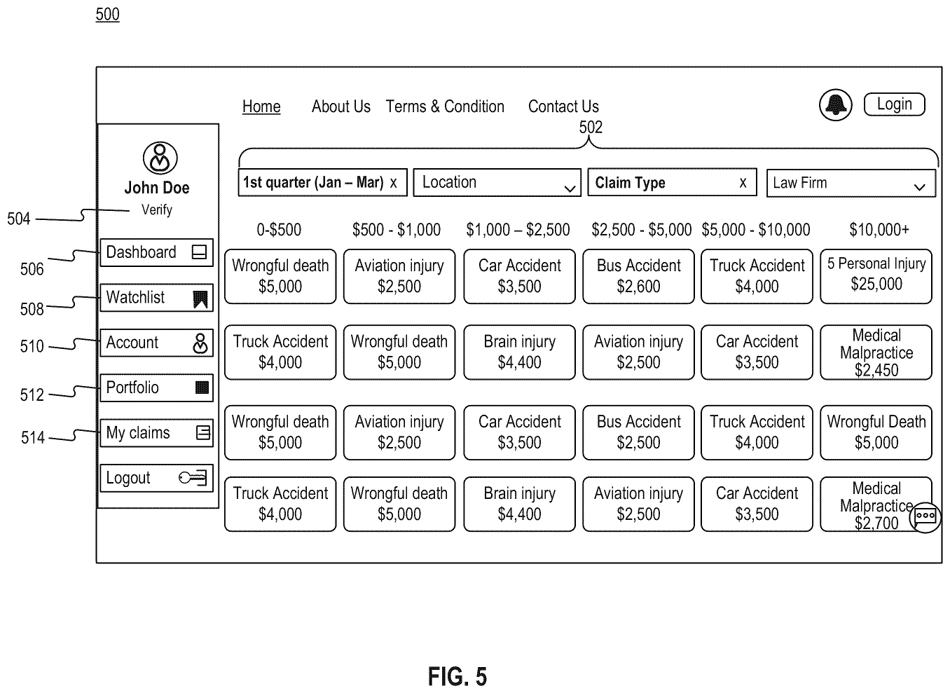

Referring to FIG. 5, an exemplary user dashboard 500 of the online marketplace platform is shown. Once logged in via, e.g., the login button 204, users may be given access to the user dashboard 500 that displays user specific information. Different groups of information may be accessible via one or more UI tabs, including but not limited to Dashboard tab 506, Watchlist tab 508, Account profile tab 510, Portfolio tab 512, and My claims tab 514. In some embodiments, user dashboard 500 may display a verification button 504, prompting the user to verify personal identity or account information, and/or a new claim button (not shown), allowing the user to list a new claim 121 or a batch of claims 121. In some embodiments, only an authorized user may have access to list a batch of claims. An authorized user may refer to a user with an authorization (e.g., digital flag) associated with their account. The authorization may include a law firm user or administrator submitting a request to the platform (e.g., via an authorize button on user dashboard 500) to authorize a legal counsel user associated with the law firm to list a batch of claims. A law firm user may refer to an administrative user associated with a particular law firm and may include a legal counsel at the law firm (e.g., partner) or an administrator at the law firm (e.g., manager). For example, a legal counsel user may only have access to a new claim button that allows the user to list a batch of claims if authorized (e.g., authorization flag set to 1 or TRUE).

In some embodiments, a user input received via the user dashboard tab 510 may prompt user dashboard 500 to display the dashboard itself, thus allowing a user to return to user dashboard 500 from another screen. User dashboard 500 may comprise a default criteria settings bar 502, comprising a set of UI elements similar to filter buttons described above with respect to FIG. 2. Default criteria settings bar 502 may allow a user to set default search criteria to surface available claims of potential interest to the user. In some embodiments, the UI for displaying available claims 121 in user dashboard 500 may have features similar to those described above with respect to SRP 300 of FIG. 3.

Watchlist tab 508 may be configured to cause user dashboard 500 to display UI for particular claims that the user previously marked as being of interest (e.g., by bookmarking). Portfolio tab 512 may be configured to cause user dashboard 500 to display UI for claims 121 that the user funded, whereas My claims tab 514 may cause display of UI for claims 121 that the user listed. In some embodiments, Portfolio tab 512 and My claims tab 514 may be activated or deactivated based on the types of the user, where user dashboard 500 for funder 113 may show portfolio tab 512 and not My claims tab 514, and where user dashboard 500 for claimant 111 or legal counsel 112 may show My claims tab 514 and not Portfolio tab 512. In other embodiments, both Portfolio tab 512 and My claims tab 514 may be activated where the user is two or more of a claimant 111, a legal counsel 112, and a funder 113.

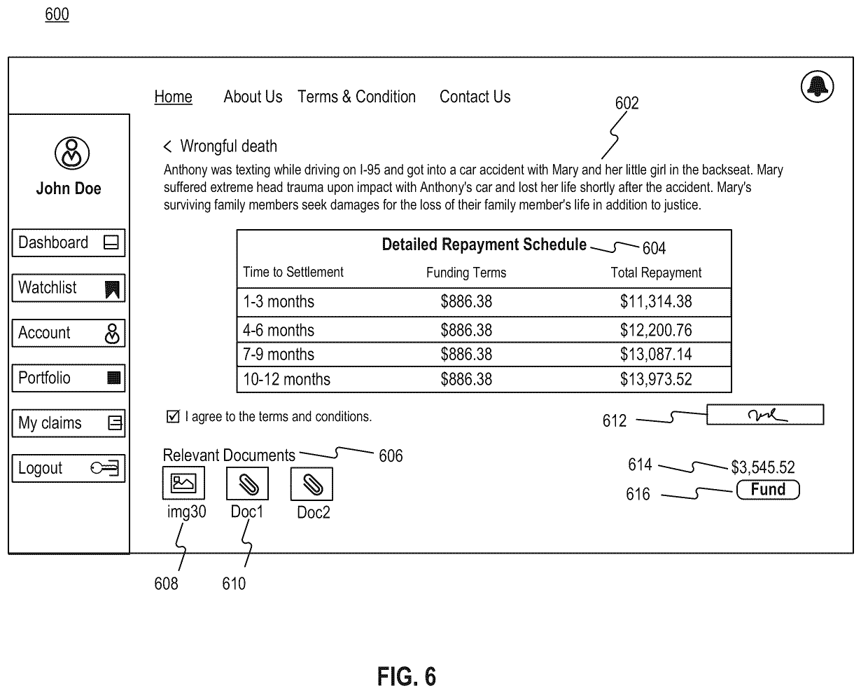

Referring to FIG. 6, an exemplary claim details page (CDP) 600 of the online marketplace platform is shown. CDP 600 may be displayed in response to a user input on any particular claim 121, such as claim button 312 described with respect to FIG. 3 above, and be configured to display detailed information of the corresponding claim 121. In some embodiments, CDP 600 may comprise a claim narrative 602, description of the parties and legal counsels 112 representing each party, a repayment schedule 604, relevant documents 606, a signature UI 612, a funding amount 614, and a funding button 616.

Repayment schedule 604 may display a schedule of return payments 134 that a prospective funder 113 would receive after providing funding advance 131 in the amount shown at funding amount 614 and after successful resolution of the case corresponding to the claim 121. For example, if the case is won or settled and case payments 132 is paid within 1-3 months, funder 113 can expect to receive $11,314.38. In some embodiments, repayment schedule 604 may breakdown how much funding advance 131 is required at different time intervals or at different milestones, and provide a total return payment 134 expected after each funding interval based on the milestones and/or total funding advance 131 provided up until the corresponding funding interval.

Relevant documents 606 may comprise images 608, documents 610, or any other electronic attachments that can assist a funder 113 in making a decision to fund the claim 121. For example, relevant documents may include photos of an accident scene and injuries, medical records, expert reports, applicable insurance policy(s), legal opinion, or the like.

Once a funder 113 is ready to fund claim 121, funder 113 may acknowledge his assent to the terms of the claim 121 and other legal representations by inserting his or her signature via signature UI 612 and fund the claim 121 by clicking on the funding button 616. A user input received on the signature UI 612 may cause CDP 600 to display a UI for recording the user's signature. The user may hand draw his or her signature using various computer input means (e.g., mouse, touchscreen, stylus) or upload a copy of his or her signature.

In further embodiments, CDP 600 may comprise multiple UI tabs (not shown) for showing different aspects of claim 121. For example, CDP 600 may comprise tabs for existing funder 113 information, legal counsel 112 information, list of messages publicly exchanged between users in connection with claim 121, list of messages exchanged between claimant 111 and legal counsel 112 in connection with claim 121, and any previously funded funding advances 131. All or a subset of the tabs may be hidden from public view and available only to the user that posted claim 121 (e.g., claimant 111, legal counsel 112), funders 113 that funded claim 121 already, or administrators of the platform. For example, only administrators may be allowed access to history of revisions made for claim 121, any issues that were raised, and how they were addressed.

When associated with a batch of claims (e.g., user interacted with claim button 312a), the CDP may include a list of the claims of the batch. Further, when a user interacts with a claim in the list, the online platform may display a CDP associated with that particular claim (e.g., CDP 600) in a same or separate window.

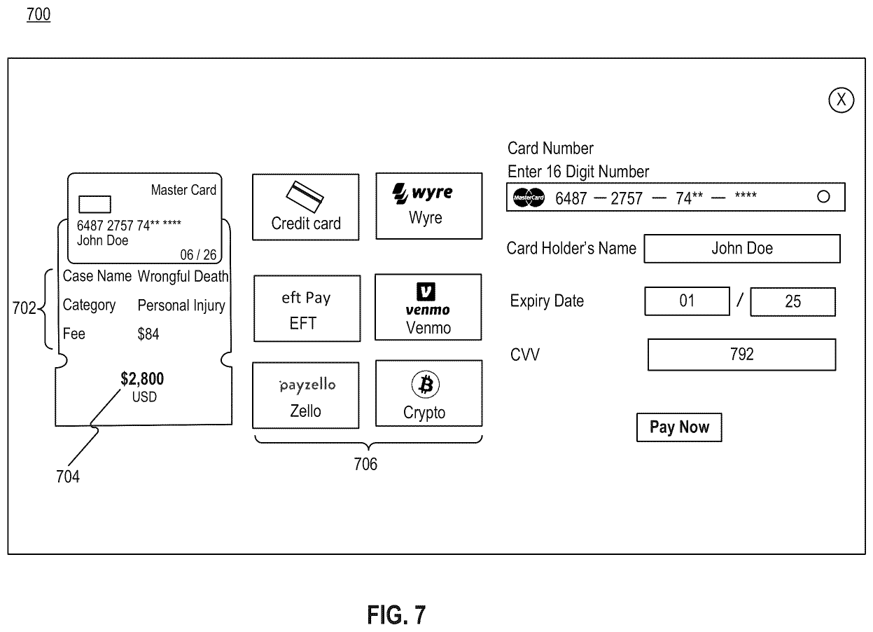

Referring to FIG. 7, exemplary payment page 700 showing payment details is shown. Payment page 700 may be configured to appear in response to a user input on funding button 616, where the user may be a funder 113. Payment page 700 may comprise claim information 702, payment amount 704, payment method selection 706, and other UI elements configured to receive user input of payment information. Claim information 702 and payment amount 704 may correspond to a claim 121 that funder 113 wishes to fund, such as the claim 121 described with respect to FIG. 6 above or a batch of claims 121. In some embodiments, payment method selection 706 may comprise different types of traditional and non-traditional payment methods, such as credit/debit card, peer-to-peer payment platforms, third-party payment services, or cryptocurrencies. Additionally or alternatively, payment methods may include offline payments such as a personal check, Cashier's Check, money order, preloaded debit card, or the like. In further embodiments, payment page 700 may comprise options for selecting payment methods previously linked to the user's account or those accepted by claimant 111 or legal counsel 112 of the current claim 121 to be funded. Still further, payment amount 704 may comprise funding amount 614, corresponding to the funding advance 131 sought by claimant 111 or legal counsel 112, in combination with a processing fee and/or a transaction fee for certain payment methods or the online platform.

In some embodiments, the online platform may be configured to generate one or more contracts between claimants 111 or legal counsel 112, and funders 113 automatically. For example, the online platform may gather information from user profiles of claimants 111 or legal counsel 112, and funders 113 to define parties to the one or more contracts, use information from claims 121, including the funding advance 131 and repayment schedule. In further embodiments, the online platform may also be configured to query user devices of claimants 111 or legal counsel 112, and funders 113 for their geographic locations and use retrieved information to select a base contract template catered to the jurisdiction where claimants 111, legal counsel 112, or funder 113 are located or to select an appropriate governing law. Additionally or alternatively, the online platform may allow claimants 111, legal counsel 112, or funders 113 to modify autogenerated contracts or upload their own contracts. Further still, the online platform may use a machine learning model to draft or modify contracts in a way that balances interest of claimants 111, legal counsel 112, and funders 113 to facilitate quick agreement between the parties.

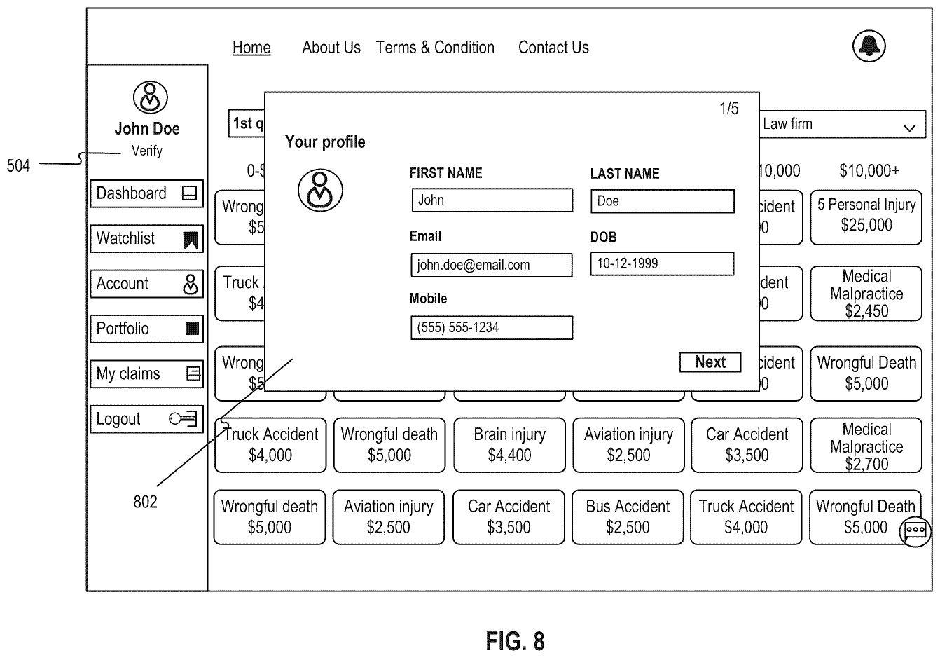

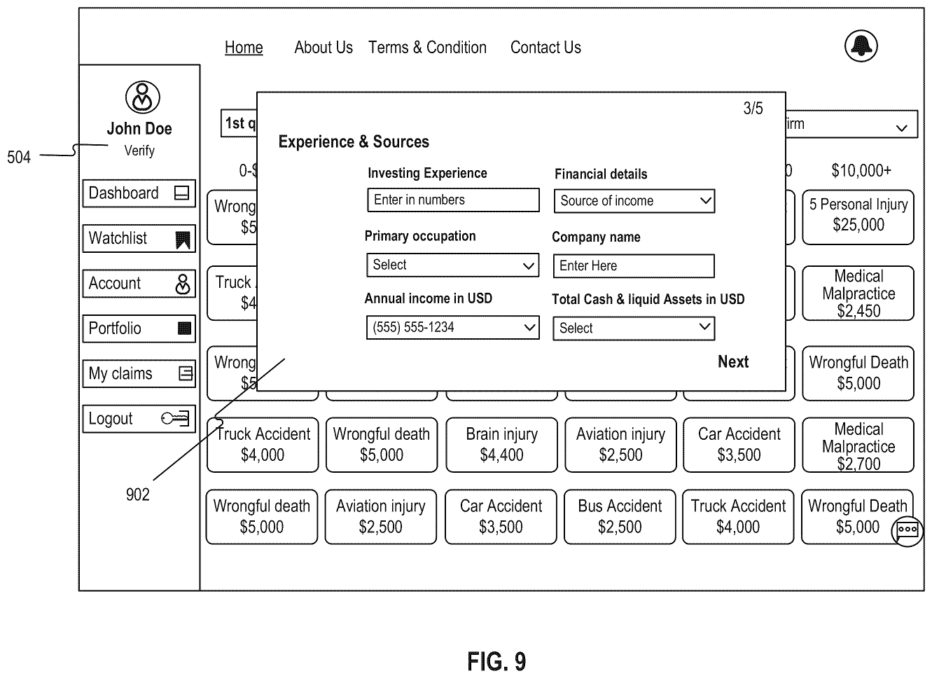

Referring to FIGS. 8 and 9, a first exemplary user profile verification page 802 and a second exemplary user profile verification page 902 (collectively exemplary user profile verification pages 802 and 902) showing basic information of a user is shown. User profile verification pages 802 and 902 may be configured to appear in response to a user input on verification button 504. Additionally or alternatively, user profile verification pages 802 and 902 may be configured to appear in response to a user input on funding button 616 if the user profile is yet to be fully verified. User profile verification pages 802 and 902 may comprise additional pages for verifying, displaying, or collecting additional information, or be combined into a single page comprising information on all such pages. Additional information may comprise, for example, information on legal counsel 112, contact information, or financial information. In some embodiments, user profile registration pages (not shown), for registering a new user, may comprise similar interfaces and/or information as user profile verification pages 802 and 902.

In some embodiments, verification button 504 may be configured to appear in user dashboard 500 when information received during user registration is insufficient or invalid for identifying personal identity or financial information of the user. And as such, exemplary user profile verification pages 802 and 902 may be configured to allow the user to correct existing information or provide additional information and/or supporting documents (e.g., copy of a photo identification card, bank statement, etc.) as attachments.

Referring to FIG. 10, an exemplary claim registration page (CRP) 1000 of the online marketplace platform is shown. CRP 1000 may comprise various UI elements for accepting user input for different claim information, such as a claim narrative 1002, a liabilities description 1004, an insurance policy limit description 1006, document uploading UI 1008, listing information 1010, repayment schedule 1012, and/or accepted payment methods 1014. In some embodiments, claimant 111 may be the sole user (other than administrators of online platform) authorized to access, delete, or modify CRP 1000 of his or her own claim 121. In other embodiments, legal counsel 112 of claimant 111 or any other user specified by claimant 111 may also be authorized to access, delete, or modify CRP 1000 of the claim 121.

In some embodiments, document uploading UI 1008 may be configured for manual or automatic processes for uploading claim-related documentation. Claim-related documentation may correspond to relevant documents 606 described above and may be provided by either the claimant 111 or the legal counsel 112. Claim-related documentation may also be subject to verification by the platform's administrators through an automatic or manual process. In some embodiments, only the legal counsel 112 may be authorized to provide claim-related documentation and claimant 111 may be prohibited in order ensure accuracy and/or reduce risk of fraud. At least a portion of the information may be verified by the disclosed platform through either automatic or manual auditing, or a combination thereof.

In some embodiments, a user may be prompted to provide claim information or documentation. For example, a claimant 111 or legal counsel 112 may be prompted (e.g., automatically by an automated auditing process, by an administrator via a manual auditing process) to provide additional claim information. In some embodiments, only legal counsel 112 may be authorized to provide requested information. For example, an administrator of the platform may request legal counsel 112 to validate or confirm claim information provided by claimant 111 or to provide a status update on a pending case.

When posting a new claim, claimant 111 or legal counsel 112 can provide information regarding their claim 121 that may assist prospective funders 113 assess strength of claim 121 and decide whether to provide funding advance 131. Such information may be input into claim narrative 1002, liabilities description 1004, insurance policy limit description 1006, where liabilities description 1004 may include any information likely to be found unfavorable to claimant 111, any third party liability claimant 111 may owe, or liability that an opposing party in the claim 121 may owe to claimant 111; and where insurance policy limit description may include policy limits of insurance policy carried by claimant 111 or the opposing party that may be available to cover all or part of any case payments 132 from a successful resolution of the case corresponding to claim 121. For ease of use or consistency, the platform may also provide a predetermined set of labels or titles (e.g., bus accident, car accident, brain injury, wrongful death) that may facilitate categorizing claims 121 into different claim types.

In some embodiments, claimant 111 or legal counsel 112 may specify, among others, an amount sought for funding advance 131 and any deadline, as well as different payment methods that a funder 113 may utilize. For example, claimant 111 or legal counsel 112 may choose to be paid through third party payment services or cryptocurrency but not bank wire. The amount sought may be selectable from a predetermined list of amounts or be freely adjustable.

In further embodiments, the online platform may be configured to generate repayment schedule 1012 for prospective funders 113 based on the information entered by claimant 111 and/or legal counsel 112. Repayment schedule 1012 may be generated based at least on a suggested repayment amount for the amount of funding advance 131 requested by claimant 111 or legal counsel 112 and/or the amount of time estimated to take for the corresponding case to be resolved. For example, the platform may suggest a higher repayment amount the longer it takes claim 121 to be resolved and claimant 111 or legal counsel 112 recovers for their claim 121. Claimant 111 or legal counsel 112 may be able to adjust any aspect of the schedule (e.g., the repayment amount, rate of return, or period to repayment) as necessary or appropriate. For example, claimant 111 or legal counsel 112 may adjust the schedule to pay a greater amount if no funder 113 responds to claim 121 or adjust to pay a lesser amount if claimant 111 or legal counsel 112 wishes to pay less. In some embodiments, CRP 1000 may also show an additional drop-down box or a blank space indicating repayment date and total amount to be repaid. In further embodiments, the platform may be configured to allow funders 113 to make counteroffers on repayment schedule 1012, which the corresponding claimant 111 or legal counsel 112 may accept, reject, or make yet another counteroffer. Additionally or alternatively, repayment schedule 1012 may be determined using a machine learning model or statistical methods that analyzes outcomes and case payments 132 of similar claims 121, such as historical claim data stored in a database of the platform or accessed (e.g., queried from a third-party database) by the platform.

In some embodiments, administrators of the online platform may audit posted claims 121 for fraud. The administrators may also audit users for authenticity and/or for preventing crimes such as money laundering. The administrators may be humans or automated systems trained (using machine learning, for example) to identify fraudulent activity.

Further still, claimants 111 or legal counsel 112 may pay more fees to the online platform and opt to make their claims 121 more visible by, for example, having their claims 121 appear at the top of search results by other users of the platform or be exposed more frequently to potential funders 113.

In some embodiments, the online platform may be configured to simplify transactions among claimants 111, legal counsel 112, and/or funders 113 by providing a standardized funding process and documentation for all transactions, protecting the interests of all parties entering in a transaction. Documentation may be completed electronically and through automated processes.

In some embodiments, an authorized user may list a batch of claims via a CRP. To list a batch of claims, the authorized user may perform similar steps or actions as described above with respect to FIG. 10 for each claim in the batch. After inputting or providing claim information for a first claim, the authorized user (e.g., legal counsel 112 authorized by a law firm user) may interact with an “Add New” button (not depicted) to add an additional claim to the batch. Additionally or alternatively, an authorized user may list a batch of claims by adding existing, unfunded, pending claims (e.g., those listed in the UI displayed in response to a user interacting with My claims tab 514). In general, an authorized user may list a batch of claims including any number of new claims and pending, unfunded claims, or funded claims for additional funding or funding on better terms.

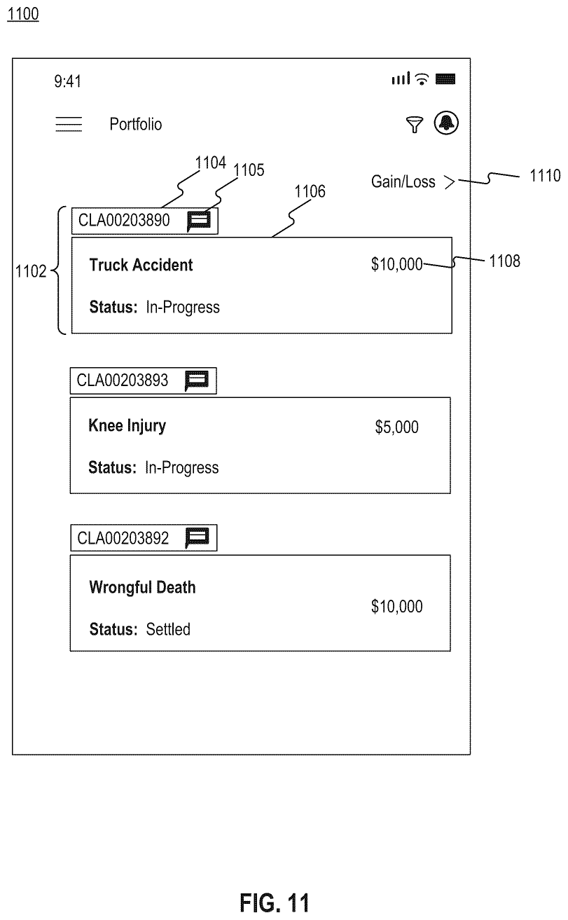

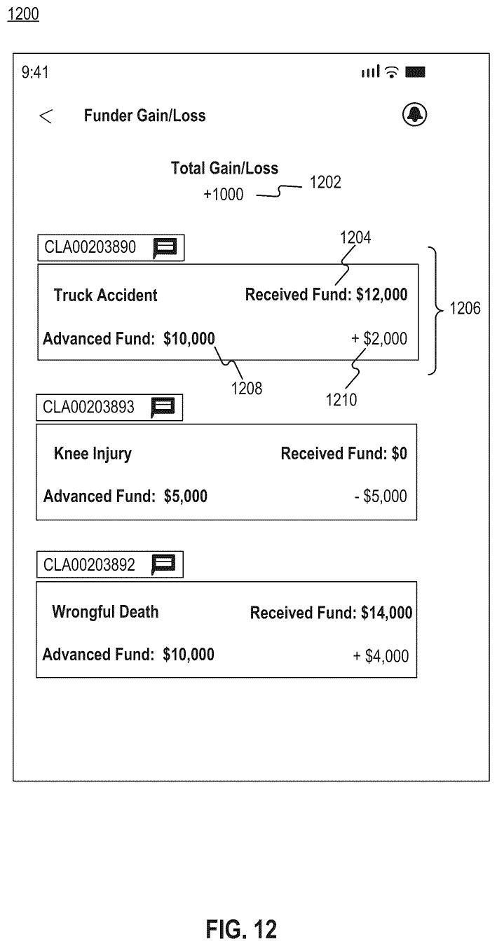

Referring to FIGS. 11 and 12, an exemplary mobile portfolio page 1100 and an exemplary mobile gains and losses page 1200, respectively, are shown, as may be displayed on a user's mobile device. The online platform may be configured to display another version of mobile portfolio page 1100 or mobile gains and losses page 1200 in response to a determination that the display screen of a user's device is capable of displaying in a predetermined minimum resolution, where information on mobile portfolio page 1100 and mobile gains and losses page 1200 may be displayed simultaneously. In some embodiments, mobile portfolio page 1100 may be configured to appear in response to a user input on portfolio tab 512.

Similar to the UI displayed in response to a user input on portfolio tab 512 described with respect to FIG. 5 above, mobile portfolio page 1100 may comprise a mobile claim block 1102. Mobile claim block 1102 may comprise a claim identification number (ID) 1104, a messaging button 1105, a claim summary box 1106, and funded amount 1108. Claim ID 1104 may be a unique sequence of characters assigned to each claim 121 and may be used to refer to specific claims 121 or batch of claims. For example, messaging button 1105 may be configured to allow a user to send a message to another user or an administrator regarding a particular claim or batch of claims, where the message may be accompanied by claim ID 1104. In some embodiments, claim ID 1104 may be displayed on any UI page described herein where a claim 121 or associated information is displayed.

Mobile gains and losses page 1200 may be configured to appear in response to a user input on the gains and losses button 1110 of FIG. 11. In some embodiments, mobile gains and losses page 1200 may be configured to provide gains and loss information for each claim 121 and/or summarize their performance for funders 113. For example, mobile gains and losses page 1200 may comprise total net gain or loss 1202 for all funded claims and/or individual gain or loss for each funded claim 121. In some embodiments, information on each claim 121 may be organized into another mobile claim block 1206, which may comprise a received fund amount indicator 1204, an advanced fund amount indicator 1208, and individual gain or loss indicator 1210.

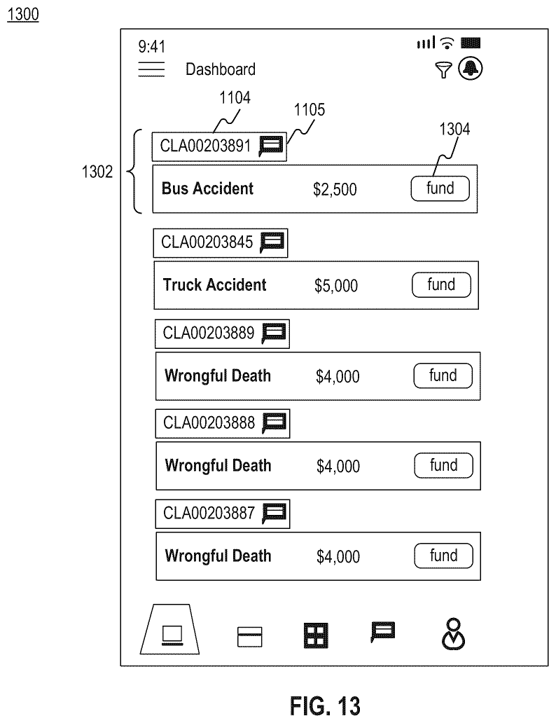

Referring to FIG. 13, an exemplary mobile funding page 1300 is shown. Mobile funding page 1300 may be configured to appear in response to a user input on either watchlist tab 508 or portfolio tab 512 to allow funder 113 to fund a particular claim 121. The online platform may be configured to display another version of mobile funding page 1300 with similar UI elements or functionalities in response to a determination that the display screen of a user's device is capable of displaying in a predetermined minimum resolution. In some embodiments, mobile funding page 1300 may comprise yet another mobile claim block 1302, comprising claim ID 1104 and messaging button 1105. Each mobile claim block 1302 may further comprise a mobile funding button 1304, configured to allow funder 113 to fund the corresponding claim 121.

In some embodiments, the online platform may comprise various interfaces that assist administrators manage the platform, and the administrators may use such interfaces to monitor, manage, approve, or reject different activities conducted on the platform, such as new claim listings or new user registrations.

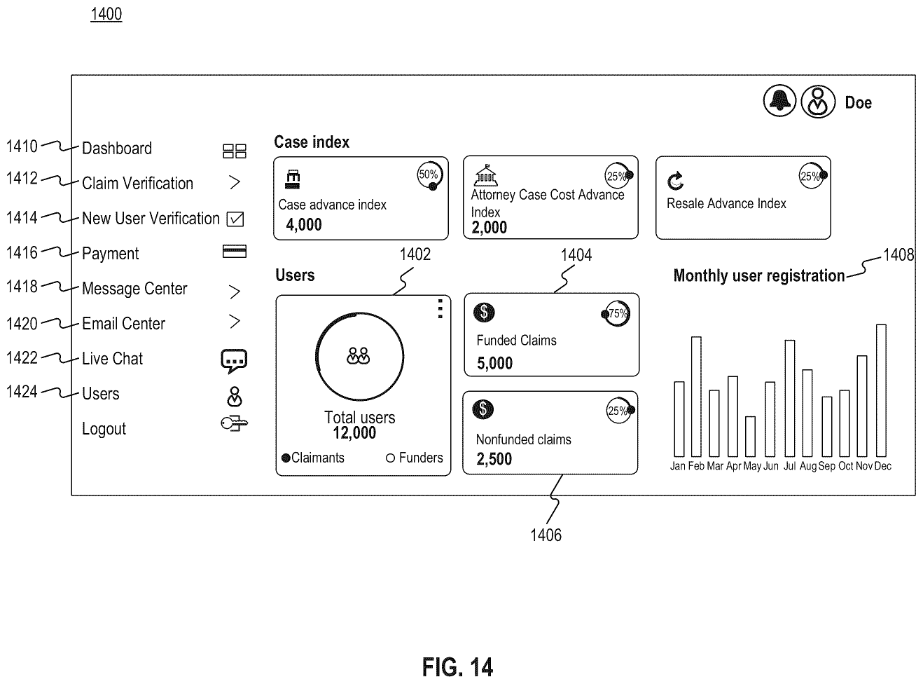

Referring to FIG. 14, an exemplary administrator dashboard 1400 of the online marketplace platform is shown. Administrator dashboard 1400 may be accessible only by authorized administrators of the online platform for managing various aspects of the online platform. For example, administrator dashboard 1400 may comprise an admin dashboard tab 1410, a claim verification tab 1412, a user verification tab 1414, a payment review tab 1416, a message center tab 1418, an email center tab 1420, a live chat tab 1422, and a users tab 1424.

Similar to user dashboard tab 510 described above, user input received via administrator dashboard tab 1410 may prompt administrator dashboard 1400 to display the dashboard itself, thus allowing a user to return to administrator dashboard 1400 from another screen. Administrator dashboard 1400 may further comprise various summaries or statistics on activities of the online platform, such as a user composition graph 1402, a funded claim composition graph 1404, a non-funded claims composition graph 1406, and a trend graph 1408. Each of user composition graph 1402, funded claim composition graph 1404, and non-funded claims composition graph 1406 may display current status of various parameters indicating activities taking place on the online platform, such as composition of users (e.g., claimants 111, legal counsels 112, and/or funders 113), number of funded claims out of all claims 121, and number of nonfunded claims out of all claims 121, respectively. These statuses are provided only as examples and may be replace with another status, metric, or statistic. Similarly, trend graph 1408 may display a bar graph of new user registration by month, which may be replaced with a graph of any other trend of interest.

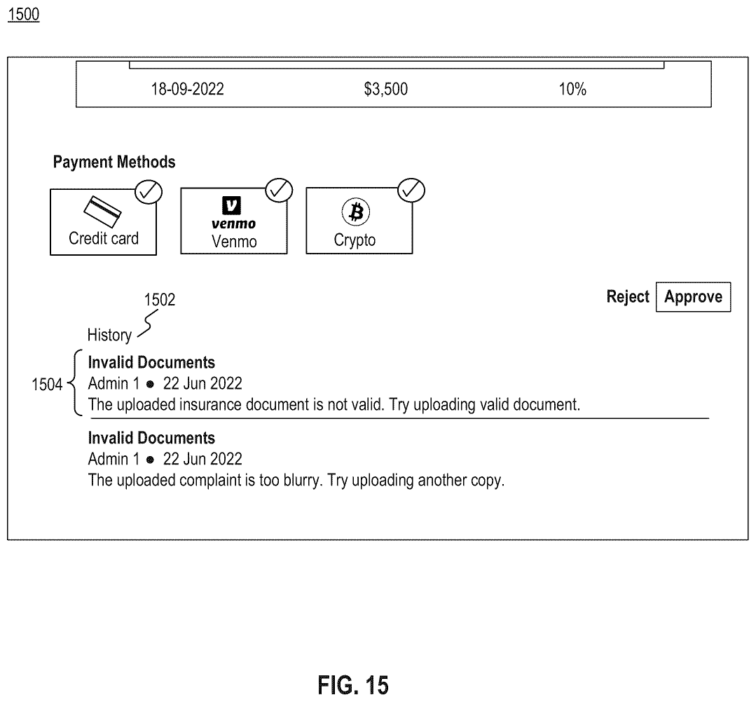

In some embodiments, claims 121 or new user registrations may require further review and/or approval by administrators. FIG. 15 shows an exemplary claim verification page (CVP) 1500. CVP 1500 may be configured to appear in response to a user input on claim verification tab 1412. In some embodiments, CVP 1500 may comprise similar UI elements as those described above with respect to CRP 1000, except for the addition of a claim verification history log 1502. Claim verification history log 1502 may comprise a log of past rejection entries 1504, each comprising information on why the corresponding claim 121 was rejected. For example, an administrator of the online platform may reject claims 121 based on determination that any of relevant documents is invalid, improper, or unrecognizable; that repayment schedule 604 is insufficient or improper; that any of accepted payment methods 1014 have failed verification process; or for any reasons that would preclude claim 121 from being listed on the online platform or prevent funders 113 from providing funding advance 131. CVP 1500 may be configured to receive user input from an administrator that rejects or approves claim 121 after reviewing changes made to claim 121. Additionally or alternatively, the review may be performed based on a preliminary analysis by the online platform; performed with an artificial intelligence review module; performed entirely by the artificial intelligence review module; performed via third-party API connected to the online platform; or any combination thereof.

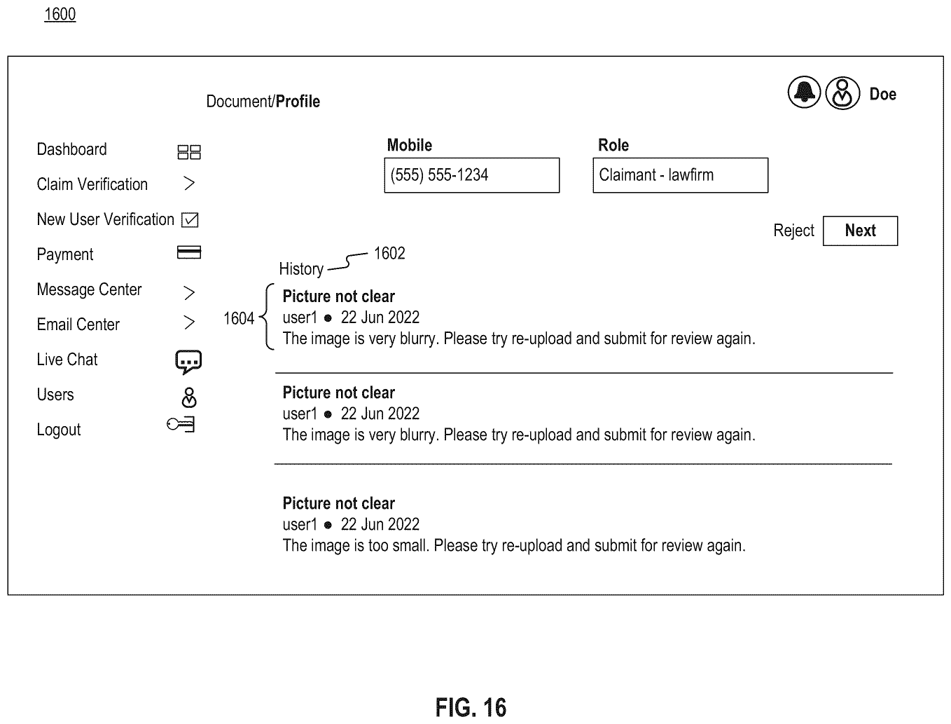

Referring to FIG. 16, an exemplary user verification page (UVP) 1600 for verifying new user registrations is shown. UVP 1600 may be configured to appear in response to a user input on new user verification tab 1414. In some embodiments, UVP 1600 may comprise UI elements configured to display information received during new user registration, as well as a user verification history log 1602. Similar to claim verification history log 1502 of CVP 1500, user verification history log 1602 may comprise a log of past rejection entries 1604, each comprising information on why the corresponding user registration was rejected. For example, an administrator of the online platform may reject claims 121 based on determination that information provided with the user registration is invalid, improper, or unrecognizable; or that the personal identity or financial accounts provided during the user registration is unable to be verified. In some embodiments, the online platform may reject claims 121 automatically upon signals from the third-party API that the personal identity or financial accounts cannot be verified.

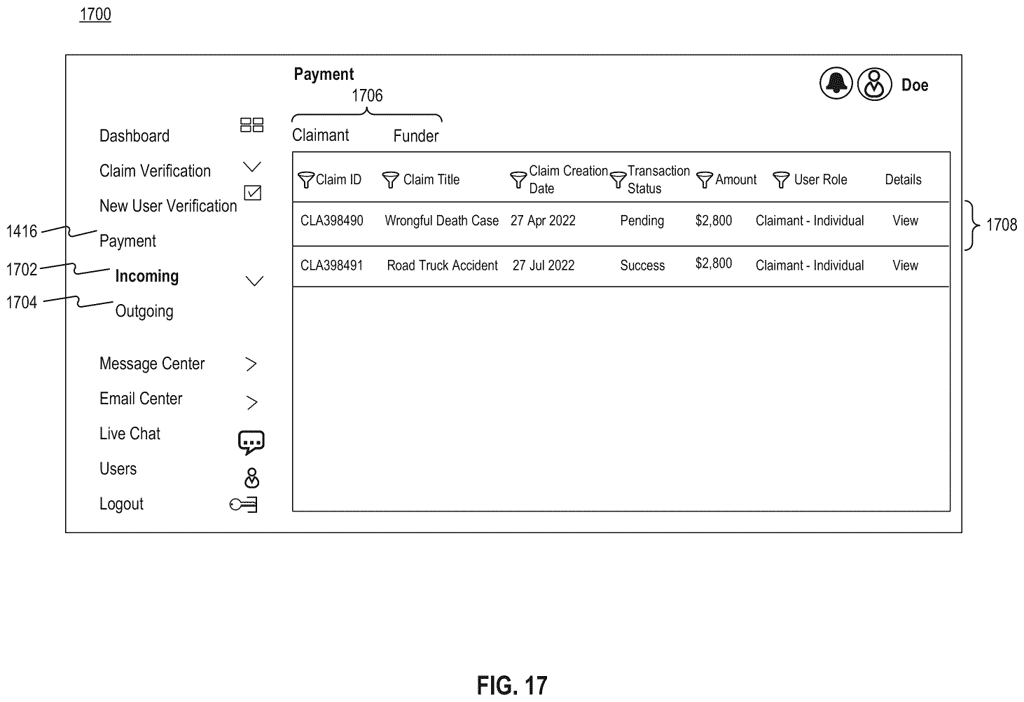

Referring to FIG. 17, exemplary payment management page 1700 is shown. Payment management page 1700 may be configured to appear in response to a user input on payment review tab 1416, which may further prompt administrator dashboard 1400 to display an incoming payment review tab 1702 and/or an outgoing payment review tab 1704. Incoming payment review tab 1702 and outgoing payment review tab 1704 may each comprise funder/claimant selector tab 1706, configured to show payment requests 1708 from either funders 113 or claimants 111.

In some embodiments, all payment transactions among claimants 111, legal counsels 112, funders 113, and the online platform may be secured by multiple layers of encryption and review processes. For example, payment management page 1700 may be configured to allow administrators of the online platform to review payment requests 1708 from claimants 111 or funders 113 and either approve or reject them as appropriate. For example, payment requests 1708 initiated by claimants 111 or funders 113 may be required to be approved by an administrator of the online platform. For example, claimant 111 may also authorize a payment request 1708 to provide return payments 134 to funder 113 upon a successful resolution of their case 121. Funder 113 may also authorize a payment request 1708 to provide funding advance 131 to fund a claim 121. In further embodiments, all funds may be required to be sent and received through the online platform. For example, a payment request 1708 from funder 113 to provide funding advance 131 may be considered an incoming payment request with respect to the online platform, where the funds received therefrom are released to the corresponding claimant 111 via an outgoing payment request. Similarly, a payment request 1708 from claimant 111 to provide return payments 134 to funder 113 may be considered an incoming payment request, where the funds received therefrom are released to the corresponding funder 113 via an outgoing payment request. Processes for receiving and releasing funds are described below in more detail with respect to FIGS. 20-24.

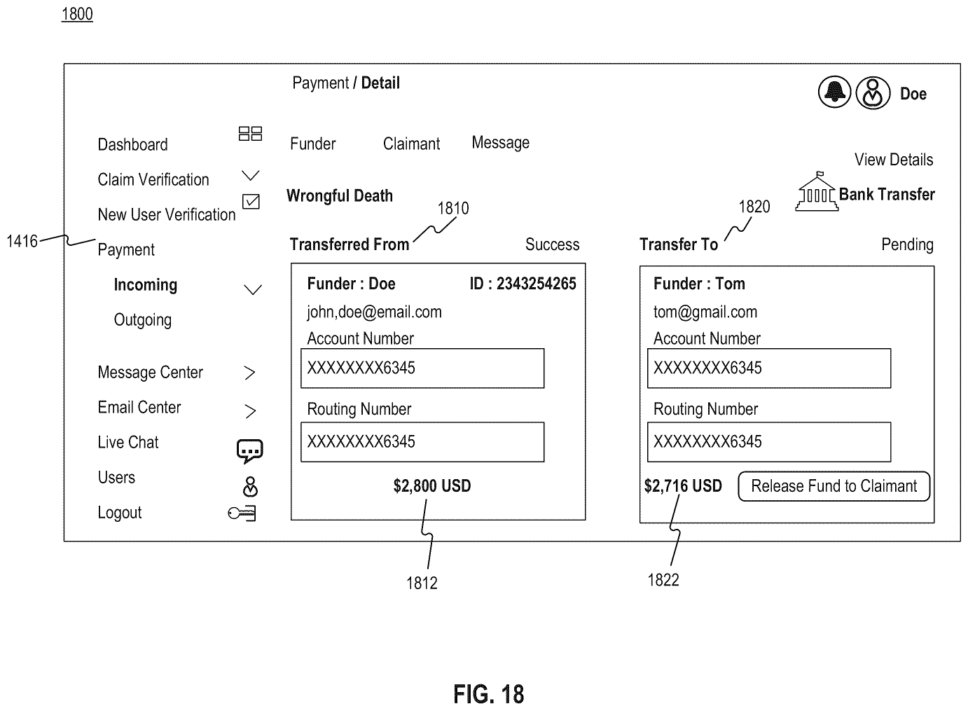

Referring to FIG. 18, an exemplary payment processing page 1800 is shown. Payment processing page 1800 may be configured to appear in response to a user input on a payment request 1708 and show details of the payment request 1708. For example, payment processing page 1800 may comprise details on an originating account 1810 and a receiving account 1820. In some embodiments, the details may also comprise a payment amount 1812, reflecting the amount to be withdrawn from originating account 1810, and net payment amount 1822, reflecting the amount to be deposited to the receiving account 1820 after fees to financial institutions (e.g., wire fees or currency conversion fees) and/or fees to the online platform.

In some embodiments, payment requests 1708 may also comprise images of check payments between claimants 111 and funders 113 or other attachments relevant to payment requests 1708. In some embodiments, payment processing page 1800 may be configured to output a list of past transactions may be available with their corresponding detail at the time of funding for record keeping or customer support purposes.

In further embodiments, each transaction processed via the online platform (e.g., payment requests 1708, claims 121, and/or contracts) may be recorded using blockchain technology. For example, the online platform may create a tamper-proof ledger that records every transaction made on the platform. Such process of keeping record may ensure that all transactions are transparent and cannot be altered, providing a high level of security and reducing the risk of fraud. In further example, the contracts may comprise self-executing contracts, where the terms of the contracts may be directly written into lines of code, which may reduce transaction costs and speed up settlement times.

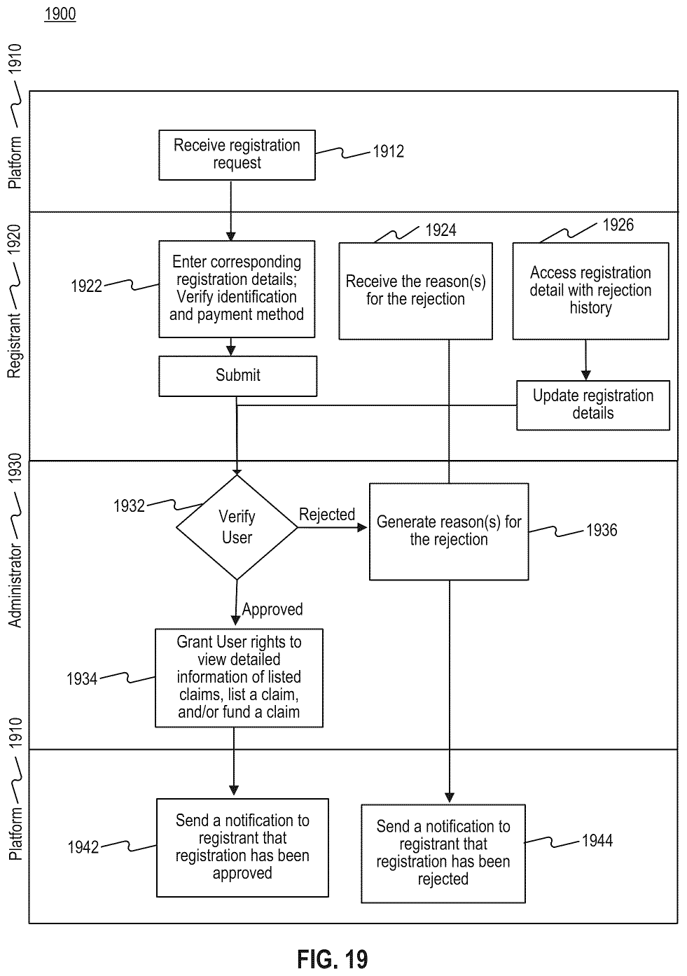

Referring to FIG. 19, a flow chart illustrating an exemplary registration process 1900 for user registration for claimants 111, legal counsels 112, or funders 113 and roles of different actors in the platform is shown. References to each entity (e.g., claimants 111, legal counsels 112, funders 113, registrant 1920, and administrator 1930) may refer to user devices that each entity may use to access and navigate through the online platform as opposed to the entities themselves. Each of claimants 111, legal counsels 112, or funders 113 may go through a similar process as a registrant 1920, albeit with different account detailed requested based on the user type. For example, registrants 1920 may be given a choice of signing up in their personal capacity or as a representative of a business entity or a law firm. Additionally or alternatively, registrants 1920 may be given another choice of signing up as a claimant 111, a legal counsel 112, a funder 113, or a combination of the three.

Registration process 1900 may begin at step 1912, where the online platform 1910 receives a registration request via, e.g., a signup button (not shown) on the online platform 1910. Registrant 1920 may proceed to entering corresponding registration details and verifying information such as personal identity and financial accounts at step 1922. Upon submission, an administrator 1930 of the online platform 1910 may review the registration details to verify registrant 1920 and either approve or reject the registration. The review may take place via an interface that is configured to appear in response to a user input on new user verification tab 1414.

Once approved, administrator 1930 may, at step 1934, grant registrant 1920 rights to view detailed information of listed claims, to list a claim, and/or fund a claim according to the user type selected by registrant 1920. If rejected, administrator 1930 may, at step 1936, generate one or more reasons for the rejection, as explained above with respect to FIG. 16. The online platform 1910 may send a notification to registrant 1920, at steps 1942 or 1944, that the registration has been approved or rejected, respectively. The notification may be generated and sent to registrant 1920 in any way suitable for catching registrant's 1920 attention, such as an email or a text message; an in-app notification; an alarm displayed in user dashboard 500 or notification button 202; or display of verification button 504.

Turning back to registrant 1920, registrant 1920 may receive the reasons for rejection at step 1924 and access registration details at step 1926. Registration process 1900 may continue again from step 1932 once registrant 1920 updates the registration details and submits the registration again.

Referring to FIG. 20, a flow chart illustrating an exemplary listing process 2000 for listing a claim 121 and being funded is shown. Listing process 2000 may begin with claimant 111 listing a claim 2012 via CRP 1000 at step 2012. In some embodiments, step 2012 may further comprise legal counsel 112 receiving notification (e.g., via email) of claim 121, and supplementing claim information by modifying information noted by claimant 111, uploading claim documents (e.g., police reports, court documents, etc.), or the like.

Claim 121 may be set as pending initially at step 2014 until it is reviewed and approved by administrator 1930. For example, administrator 1930 may review claim 121 and accompanying documents at step 2032 and verify (i.e., approve or reject) claim 121 at step 2034 using an interface similar to CVP 1500. In some embodiments, administrator 1930 may redact any personally identifiable information or sensitive information from claim 121 before approving claim 121. Such redaction may be performed automatically by an analytics component of the online platform (not shown), which may detect and redact sensitive information from claim documents, so that they can be made accessible to users of the online platform with little to no privacy concerns.

In further embodiments, online platform 1910 may analyze claim 121 and generate a rating using the analytics component. The ratings may be generated using a machine learning model of the analytics component, trained on data gathered from the litigation funding industry and claims 121 being processed through the online platform. In some embodiments, the machine learning model may utilize different statistical methods and machine learning algorithms available in the art to determine the likelihood of success for each claim 121 based on metrics gathered from other litigation funding services and the online platform for claims of similar type, scope, and/or fact pattern. For example, data gathered to train the analytics component for a personal injury claim may include amount of damages sought, amount of insurance coverage, amount settled or awarded, details of police report, and/or medical details. Parameters of claim 121 used to determine the likelihood of success may include, for example, whether the claim is a new listing or a relisting, amount of damages sought, amount of insurance coverage, details of police report, and/or medical details.

In some embodiments, the analytics component may be configured to determine a rating for a batch of claims. For example, the rating for a batch of claims may be based on the ratings of each claim in the batch of claims (e.g., weighted sum). In some embodiments, the online platform may provide the rating of a claim to a user. For example, the online platform may display a rating for each listed claim or batch of claims to a funder 113.

Once approved, claim 121 is listed on the online platform 1910 at step 2022, where funders 113 can browse the listed claims 121 at step 2042 via, e.g., home page 200, SRP 300, CDP 600 or the like. If rejected, claimant 111 may enter additional or alternative information at step 2016, after which claim 121 may go through listing process 2000 again at step 2014.

Turning back to step 2042, funder 113 may decide to fund a desired claim 121 at step 2044 via interfaces such as CDP 600 or mobile funding page 1300. Such action may generate a payment request 1708, which is reviewed via payment management page 1700 and approved via payment processing page 1800 to receive funds from funder 113 at step 2024. Upon receipt, online platform 1910 may send a notification of the payment to administrator 1930 at step 2026 and generate an outgoing payment request for release of the payment to claimant 111. Administrator 1930 may review and approve the outgoing payment request via payment management page 1700 and payment processing page 1800 for release to claimant 111 at step 2036.

In some embodiments, funding a claim 121 and receiving funding advance 131 may further comprise entering into a formal contract between claimant 111 and funder 113. As described above, online platform 1910 may generate and provide one or more contracts for claimant 111 and funder 113 to sign. The contracts may be sent to legal counsel 112 also so that they may review and counsel claimant 111. Successful execution of the contracts may process the payment request 1708 from funder 113 to transfer funds from funder 113 to the online platform 1910, which is eventually transferred to claimant 111 as described above.

In further embodiments, one claim 121 may accept funding from more than one funders 113, which may allow even greater amount of funding advance 131 for claimants 111 or allow funders 113 to reduce their risk of loss. Any return payment 134 obtained from a claim 121 with multiple funders may be split based on each funder's share in the claim 121 as determined by a ratio between the amount of funding advance 131 each funder 113 provided and the total amount of funding advance. Additionally or alternatively, one claim 121 may be associated with more than one claimant 111, which may allow a group of claimants 111 to seek recourse from the same opposing party (e.g., multiple claimants with a workplace injury claim against a common employer).

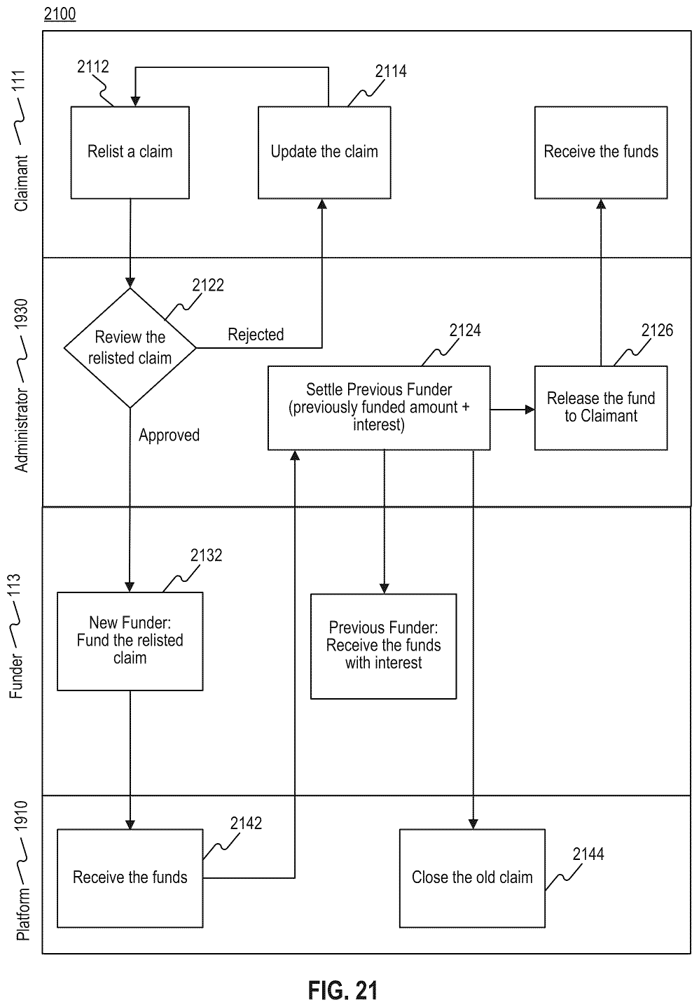

Referring to FIG. 21, a flow chart illustrating an exemplary relisting process 2100 for relisting a claim 121 by a claimant 111 and switching to a new funder 113 is shown. As used herein, relisting a claim 121 may refer to adjusting an amount of funding advance 131 initially asked for in claim 121, which has been funded already. A relisted claim 121 may also comprise a new repayment schedule 604 calculated based on the new funding advance 131 amount.

Relisting process 2100 may begin at either step 2112 or 2114, where claimant 111 may decide to relist claim 121 on their own or update claim 121 in response to a rejection from administrator 1930. At step 2122, administrator 1930 may review the relisted claim 121 and either approve or reject it. The approved claim 121 may be listed on online platform 1910 and accessible to funders 113, where a new funder 113 may take interest and request to fund the relisted claim 121 with a new funding advance 131 amount. Having received the new funds at step 2142, administrator 1930 may settle the previous funder 113 at step 2124 by processing an outgoing payment request to the previous funder 113 in the amount equaling the previous funding advance 131 plus interest determined based on previous repayment schedule 604. The previous funder 113 would then be considered fully resolved from claim 121, thus being entitled to no other payment even if claim 121 is successfully resolved. In some embodiments, relisting process 2100 may give an option to the previous funder 113 to accept the settlement or to offer even more funding advance 131 or less interest for return payments 134 in order to stay vested in claim 121. In such embodiments, relisting process 2100 may accept an alternating series of bids from the previous funder and the new funder to determine who may stay vested in claim 121.

After step 2123, relisting process 2100 may further comprise closing the previous claim at step 2144 and/or releasing the newly received fund to claimant 111 at step 2126. Claimant 111 would then be free to continue pursuing their case for a successful resolution (e.g., court awarded judgement or settlement). Any return payment 134 upon successful resolution of the case may be paid to the new funder 113 instead of the previous funder.

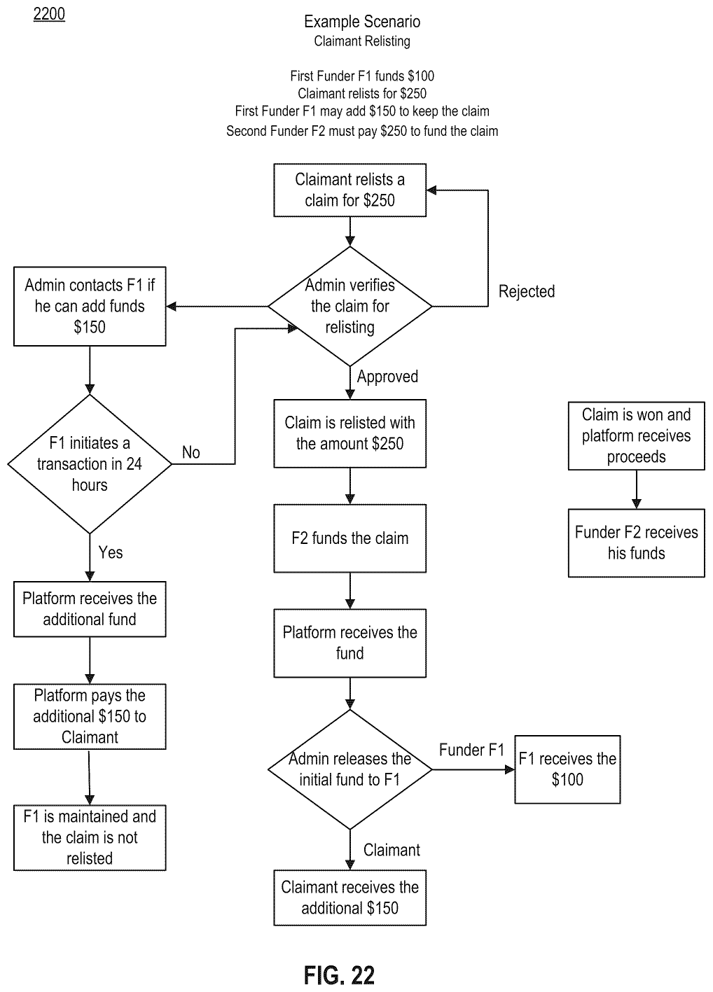

FIG. 22 shows a flow chart illustrating another exemplary hypothetical relisting process 2200 for relisting a claim 121 by a claimant 111 using hypothetical values to illustrate the flow of funds. Steps of hypothetical relisting process 2200 may be substantially similar to those of relisting process 2100 of FIG. 21. Any steps of relisting process 2100 not shown with respect to hypothetical relisting process 2200 are implied, and vice versa.

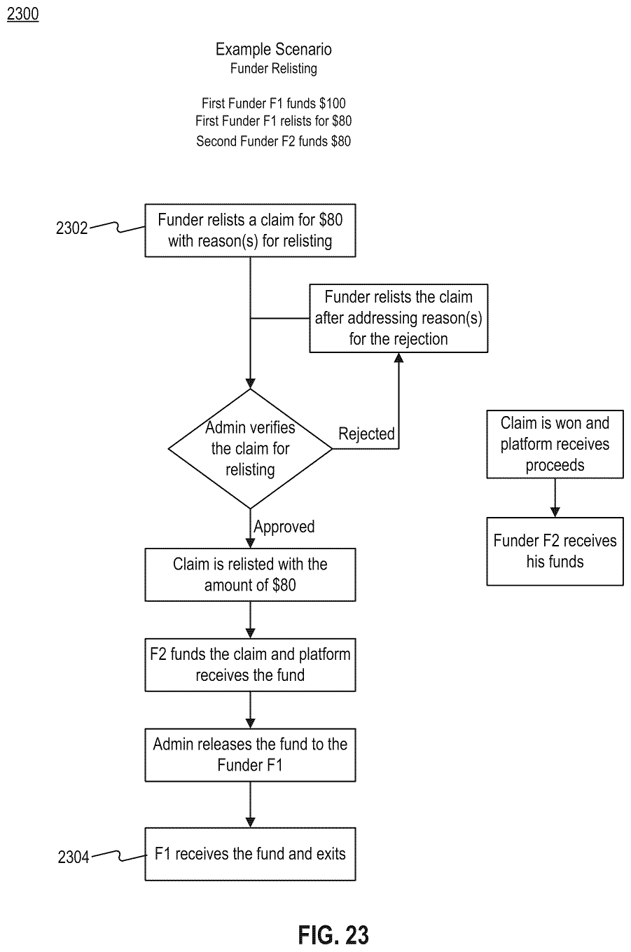

Referring to FIG. 23, a flow chart illustrating another exemplary hypothetical relisting process 2300 for relisting a claim 121 is shown with another set of hypothetical values. Hypothetical relisting process 2300 may differ from processes 2100 and 2200 based on the fact that funder 113 initiates the relisting instead of claimant 111. Such relisting process 2300 may be desirable when the original funder 113 wishes to remove themselves from claim 121 due to, for example, development of new facts that make it less likely for claimant 111 resolve the case successfully, delay in court proceedings, or any other reason that the original funder 113 may decide is enough to discontinue.

Relisting process 2300 may begin at step 2302, where the original funder 113 relists claim 121 with a new funding advance 131 amount and one or more reasons for relisting. After the series of steps shown in FIG. 23, leading to step 2304, the original funder 113 may receive the new funds from the new funder and exit. In some embodiments, the new funding advance 131 amount may be less than the amount initially promised by repayment schedule 604, because the original funder 113 has chosen to relist the claim and exit, thus amounting to an early termination of the relationship between claimant 111 and original funder 113.

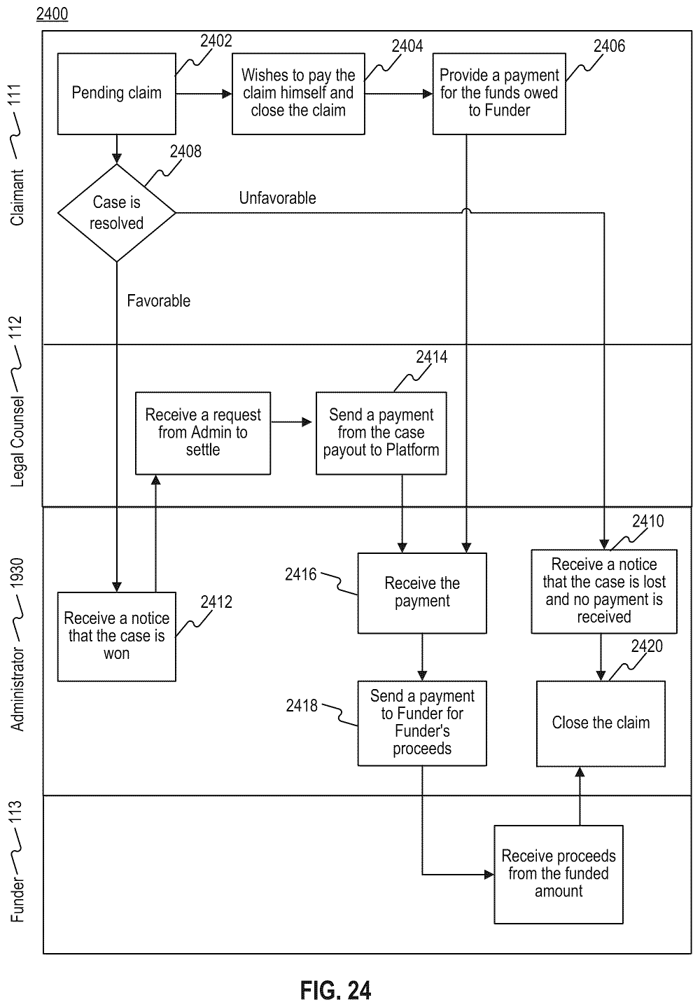

Referring to FIG. 24, a flow chart illustrating an exemplary closing process 2400 for settling or closing a claim is shown. Closing process 2400 may begin with a pending claim 121 at step 2402. In some embodiments, at step 2404, claimant 111 of the pending claim 121 may wish to pay for return payments 134 themselves and close the claim regardless of the resolution of the corresponding case. In such cases, claimant 111 may provide a payment for return payments 134 promised to funder 113 according to repayment schedule 604 at step 2406. Closing process 2400 may then proceed to step 2418, which is described below in latter part of closing process 2400.

In another embodiment where the corresponding case is resolved unsuccessfully at step 2408, closing process 2400 may proceed to step 2410, where administrator 1930 may receive a notice that the case is lost and no case payment 132 is received. Administrator 1930 may independently verify such notice using documents submitted by claimant 111 or legal counsel 112. Once verified, administrator 1930 may close claim 121 without paying funder 113, as was stipulated from the beginning.

In yet another embodiment where the corresponding case is resolved successfully at step 2408, closing process may proceed to step 2412, where administrator 1930 may receive a notice that the case is won or settled. Administrator 1930 may then send a request to legal counsel 112 (or claimant 111) to settle claim 121, in response to which legal counsel 112 (or claimant 111) may send funds for return payment 134 at step 2414. As described above, payment from legal counsel 112 to the online platform 1910 may comprise only the portion of case payment 132 that funder 113 is entitled to previously-executed contracts between claimant 111 and funder 113 and/or as specified in the repayment schedule at the time of funding. In some embodiments, legal counsel 112 may also pay other costs of the case such as medical invoices, which may have superior or inferior lien to case payment 132 relative to return payments 134. Once administrator 1930 processes the corresponding incoming payment request and receives the funds at 2416, administrator 1930 may also process an outgoing payment request to funder 113 at step 2418 for return payments 134 to funder 113. Claim 121 may be closed at step 2420 once all payments are processed and outcomes of the case are recorded.

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .NET FRAMEWORK®, .NET COMPACT FRAMEWORK® (and related languages, such as VISUAL BASIC®, C, etc.), JAVA®, C++, Objective-C, SWIFT®, HTML, JAVASCRIPT®, HTML/AJAX combinations, XML, or HTML and CSS.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The examples are to be construed as non-exclusive. Furthermore, the steps of the disclosed methods may be modified in any manner, including by reordering steps and/or inserting or deleting steps. It is intended, therefore, that the specification and examples be considered as illustrative only.

What is claimed is:

1. A computer-implemented system for facilitating litigation funding advances, the system comprising:
at least one non-transitory computer-readable medium configured to store instructions; and
at least one processor configured to execute the instructions to perform operations comprising:
receiving claim information on a contentious batch of one or more claims through an electronic portal;
surfacing the claim information to one or more potential funders via the electronic portal, wherein the claim information comprises payment schedule in return for a funding advance by the one or more potential funders;
receiving one or more user input from a first funder among the one or more potential funders to transfer the funding advance for a first batch of one or more claims corresponding to the claim information; and
initiating a first secure transaction between the one or more potential funders and a legal counsel of the first batch of one or more claims.

2. The computer-implemented system of claim 1, wherein surfacing the claim information to the one or more potential funders comprises:
displaying the contentious batch of one or more claims among a series of additional batches of one or more claims; and
providing user interface elements for filtering the contentious batch of one or more claims and the series of additional batches of one or more claims,
wherein the user interface elements are configured to receive one or more user inputs comprising one or more parameters for filtering.

3. The computer-implemented system of claim 1, wherein surfacing the claim information to the one or more potential funders comprises:
displaying the contentious batch of one or more claims among a series of additional batches of one or more claims;
determining amounts of impact on an online platform caused by the contentious batch of one or more claims and the series of additional batches of one or more claims; and
arranging the contentious batch of one or more claims among the series of additional batches of one or more claims based on the determined amounts of impact.

4. The computer-implemented system of claim 1, wherein surfacing the claim information to the one or more potential funders comprises:
controlling access to the claim information based on whether a user is logged into an online platform.

5. The computer-implemented system of claim 1, wherein initiating the first secure transaction between the first funder and the legal counsel of the first batch of one or more claims comprises:
receiving an incoming payment request from the first funder to transfer the funding advance to an online platform;
reviewing and approving the incoming payment request;
generating an outgoing payment request to the legal counsel to transfer the funding advance to the legal counsel; and
reviewing and approving the outgoing payment request.

6. The computer-implemented system of claim 1, wherein the operations further comprise:
receiving a notification of a successful resolution of the first batch of one or more claims; and
initiating a second secure transaction between the legal counsel and the first funder in an amount stipulated by the payment schedule.

7. The computer-implemented system of claim 1, wherein the operations further comprise:
receiving a notification of an unsuccessful resolution of the first batch of one or more claims; and
closing the first batch of one or more claims without any payment to the first funder.

8. A computer-implemented method for facilitating litigation funding advances, the method comprising:
receiving claim information on a contentious batch of one or more claims through an electronic portal;
surfacing the claim information to one or more potential funders via the electronic portal, wherein the claim information comprises payment schedule in return for a funding advance by the one or more potential funders;
receiving one or more user input from a first funder among the one or more potential funders to transfer the funding advance for a first batch of one or more claims corresponding to the claim information; and
initiating a first secure transaction between the one or more potential funders and a legal counsel of the first batch of one or more claims.

9. The computer-implemented method of claim 8, wherein surfacing the claim information to the one or more potential funders comprises:
displaying the contentious batch of one or more claims among a series of additional batches of one or more claims; and
providing user interface elements for filtering the contentious batch of one or more claims and the series of additional batches of one or more claims,
wherein the user interface elements are configured to receive one or more user inputs comprising one or more parameters for filtering.

10. The computer-implemented method of claim 8, wherein surfacing the claim information to the one or more potential funders comprises:
displaying the contentious batch of one or more claims among a series of additional batches of one or more claims;
determining amounts of impact on an online platform caused by the contentious batch of one or more claims and the series of additional batches of one or more claims; and
arranging the contentious batch of one or more claims among the series of additional batches of one or more claims based on the determined amounts of impact.

11. The computer-implemented method of claim 8, wherein surfacing the claim information to the one or more potential funders comprises:
controlling access to the claim information based on whether a user is logged into an online platform.

12. The computer-implemented method of claim 8, wherein initiating the first secure transaction between the first funder and the legal counsel of the first batch of one or more claims comprises:
receiving an incoming payment request from the first funder to transfer the funding advance to an online platform;
reviewing and approving the incoming payment request;
generating an outgoing payment request to the legal counsel to transfer the funding advance to the legal counsel; and
reviewing and approving the outgoing payment request.

13. The computer-implemented method of claim 8, further comprising:
receiving a notification of a successful resolution of the first batch of one or more claims; and
initiating a second secure transaction between the legal counsel and the first funder in an amount stipulated by the payment schedule.

14. The computer-implemented method of claim 8, further comprising:
receiving a notification of an unsuccessful resolution of the first batch of one or more claims; and
closing the first batch of one or more claims without any payment to the first funder.

15. A non-transitory computer readable medium storing instructions which, when executed, cause at least one processor to perform operations for facilitating litigation funding advances, the operations comprising:
receiving claim information on a contentious batch of one or more claims through an electronic portal;
surfacing the claim information to one or more potential funders via the electronic portal, wherein the claim information comprises payment schedule in return for a funding advance by the one or more potential funders;
receiving one or more user input from a first funder among the one or more potential funders to transfer the funding advance for a first batch of one or more claims corresponding to the claim information; and
initiating a first secure transaction between the one or more potential funders and a legal counsel of the first batch of one or more claims.

16. The non-transitory computer readable medium of claim 15, wherein surfacing the claim information to the one or more potential funders comprises:
displaying the contentious batch of one or more claims among a series of additional batches of one or more claims; and
providing user interface elements for filtering the contentious batch of one or more claims and the series of additional batches of one or more claims,
wherein the user interface elements are configured to receive one or more user inputs comprising one or more parameters for filtering.

17. The non-transitory computer readable medium of claim 15, wherein surfacing the claim information to the one or more potential funders comprises:
controlling access to the claim information based on whether a user is logged into an online platform.

18. The non-transitory computer readable medium of claim 15, wherein initiating the first secure transaction between the first funder and the legal counsel of the first batch of one or more claims comprises:
receiving an incoming payment request from the first funder to transfer the funding advance to an online platform;
reviewing and approving the incoming payment request;
generating an outgoing payment request to the legal counsel to transfer the funding advance to the legal counsel; and
reviewing and approving the outgoing payment request.

19. The non-transitory computer readable medium of claim 15, wherein the operations further comprise:
receiving a notification of a successful resolution of the first batch of one or more claims; and
initiating a second secure transaction between the legal counsel and the first funder in an amount stipulated by the payment schedule.

20. The non-transitory computer readable medium of claim 15, wherein the operations further comprise:
receiving a notification of an unsuccessful resolution of the first batch of one or more claims; and
closing the first batch of one or more claims without any payment to the first funder.
